(19) United States
(12) Patent Application Publication
(10) Pub. No.: US 2026/0057509 A1
(43) Pub. Date: Feb. 26, 2026

(54) AUTOMATIC PROBE HEAD MONITOR FOR MERCURY PROBE MEASUREMENTS

(71) Applicant: Four Dimensions, Inc., Hayward, CA (US)

(72) Inventors: Jian MI, San Jose, CA (US); Jung LEE, San Jose, CA (US); Jerry CUTINI, Pismo Beach, CA (US); Michael WONG, Fremont, CA (US); Tatiana DIMITROVA, Hayward, CA (US)

(73) Assignee: Four Dimensions, Inc., Hayward, CA (US)

(21) Appl. No.: 19/308,118

(22) Filed: Aug. 22, 2025

Related U.S. Application Data
(60) Provisional application No. 63/686,650, filed on Aug. 23, 2024.

(51) Int. Cl. G06T 7/00; G06T 7/62; G06T 7/73; G06V 10/44; G06V 10/764

(52) U.S. Cl. CPC G06T 7/001; G06T 7/62; G06T 7/73; G06V 10/44; G06V 10/764; G06T 2207/10016; G06T 2207/30164

(57) ABSTRACT

The technology disclosed relates to a system and methods for monitoring a probe measurement system, such as monitoring the condition of a probe head or detecting a defect of a probe head. A captured image of a probe head can be processed using an image processing model to extract a feature of the probe head, and the extracted feature can be analyzed to determine a condition indicator and generate a defect score. A defect score can be evaluated based on a pre-defined threshold, and a particular defect score satisfying the pre-defined threshold can indicate that there is a nonconformance associated with the determined indicator, such as a probe head defect. Furthermore, a nonconformance record can be logged for the probe head in response to a defect score satisfying a pre-defined threshold.

### PRIORITY APPLICATION

This application claims the benefit of U.S. Provisional Patent Application No. 63/686,650 (Atty. Docket No. 4DIM 1002-1) filed 23 Aug. 2024, which is incorporated herein by reference.

### BACKGROUND

### Field

The technology disclosed generally relates to systems and methods for monitoring the operational integrity of probe measurement systems. More specifically, the technology disclosed relates to automatic monitoring of probe heads, such as those used in mercury probe metrology systems, used in semiconductor wafer manufacturing, using computer vision-based defect inspection system to detect probe degradation in real time or near-real time and proactively maintain measurement accuracy without interrupting normal system operation.

### Description of Related Art

Probing systems used in semiconductor manufacturing, such as mercury probe metrology systems, are critical for characterizing the electrical properties of wafers and other substrates. Over time, the integrity of the probe head degrades due to contamination, physical wear, and environmental exposure. Degradation of the probe head can potentially lead to inaccurate measurements, product defects, and loss of profit during forced downtime. Conventional quality assurance methods require users to shut down the equipment, manually disassemble the system, and inspect the probe head under a microscope. The inspection process is time-consuming, technically challenging, and prone to human error due to reliance on subjective visual assessment of the probe head. As a result, manufacturers are caught between inspecting too often, which wastes time and resources, and inspecting too infrequently, which risks production errors and wafer damage.

An opportunity arises to provide a system that can automate the probe head maintenance workflow through integrated imaging hardware and image analysis to detect defects on the probe head without halting operation. An opportunity also arises to passively monitor the condition of a probe head in real time in order to identify common defects and quantify degradation over time. The technology disclosed offers a probe monitoring solution that replaces a reactive manual process with a proactive quality control tool that enables data-driven decisions to reduce waste, protect wafers, and extend equipment life.

### SUMMARY

The technology disclosed relates to a system and methods for monitoring the condition and operation of a probing system, such as a probe head condition or defect status. One disclosed method includes capturing an image of a probe head using an imaging device (e.g., a camera), processing the captured image using an image processing model to extract a feature of the captured image of the probe head, and analyzing the extracted feature to determine a condition indicator for the probe head. Disclosed methods may also include generating a defect score based, at least in part, on the determined condition indictor. Some disclosed methods can include analyzing two or more extracted features, determining a condition indicator based on at least two of the two or more extracted features, and/or determining two or more condition indicators. A defect score may be generated based, at least in part, on data associated with two or more condition indicators. For example, one or more features may be extracted and analyzed to determine a condition indicator related to silicon carbide spikes (or some other form of particle build-up) detected on the surface of a mercury probe head. Furthermore, another one or more features may be extracted and analyzed to determine another condition indicator related to mercury residue (or some other chemical residue contaminant) on the surface of the mercury probe head. One defect score may be generated based on silicon carbide spike build-up and another defect score may be generated based on mercury residue contamination, or alternatively, one defect score may be generated based on a combination of silicon carbide spike build-up and mercury residue contamination.

Many disclosed methods can further include evaluating at least one defect score based on a pre-defined threshold stored in a memory, and a particular defect score satisfying the pre-defined threshold can indicate a nonconformance in association with the determined condition indicator. For example, a defect score indicating silicon carbide spike build-up on a probe head exceeding a pre-defined threshold can indicate that the probe head status is not in conformance with an allowable operation status. A nonconformance record may be logged for the probe head in a data log in response to a generated defect score satisfying a pre-defined threshold, and may include a timestamp and data identifying at least one of the extracted features, the determined condition indicator, and/or the generated defect score. In some implementations, a presentation of a notification is prompted (e.g., via a display device), such as a warning alert based on a nonconformance record. For example, the presented notification may include one or more of a recommendation to initiate an inspection of the probe head, a maintenance action related to the probe head, or a replacement of the probe head.

In some implementations of the technology disclosed, an extracted feature from the captured image is an anomaly detection feature based on one or more measured attributes of the captured image. An attribute of the one or more attributes can be an anomalous feature detection variable, e.g., a variable identifying one or more anomalous features detected within at least a portion of the captured image (e.g., a recognized object or shape, such as a “blob” within the image, recognized at a particular location within a particular region). An anomalous feature can be associated with at least one of a signal intensity (e.g., a quantitative or qualitative color metric), a contrast, a brightness, a boundary attribute, and/or a region attribute. A boundary attribute can be a feature associated with an object recognized in the captured image, e.g., a data feature based on one or more of a perimeter, circularity, curl, compactness, convexity, convex hull, convex deficiency, signature, length, diameter, major axis, minor axis, or eccentricity. A region attribute can be a feature associated with an object recognized in the captured image, e.g., a data feature based on one or more of an area, bounding box, moment invariant(s), elongation, caliper, dimensionality, solidarity, sphericity, texture, topological descriptor(s), convexity, or compactness.

An attribute of the one or more attributes can be an anomaly classification variable identifying one or more anomaly classes detected within at least a portion of the captured image, wherein the anomaly classes identified by the anomaly classification variable are determined based, at least in part, on a detected anomalous feature. An attribute of the one or more attributes can be an anomaly frequency variable quantifying a count of one or more anomalies detected within a portion of the captured image. An attribute of the one or more attributes can be an anomaly localization variable identifying a location of an anomaly detected within at least a portion of a captured image, wherein the location of the anomaly is defined relative to a surface area of the probe head visible within the captured image. An attribute of the one or more attributes can be an anomaly size variable quantifying a size of an anomaly detected within at least a portion of the captured image, wherein the size of the anomaly is determined based on one or more of a diameter, a width, a length, a bounding box, and a surface area. An attribute of the one or more attributes can be an anomaly class density variable quantifying a density of an anomaly class detected within at least a portion of the captured image. For example, a density of an anomaly class can be based on one or more of an average size of one or more anomalies detected within at least the portion of the captured image, an aggregate size of the one or more anomalies detected within at least the portion of the captured image, and/or an aggregate surface area of the one or more anomalies detected within at least the portion of the captured image.

The determined condition indicator may be associated with a particle build-up on the surface of the probe head, such as a silicon carbide spike. Alternatively, the determined condition indicator may be associated with a chemical contamination of the surface of the probe head, such as mercury residue. Furthermore, the determined condition indicator may be associated with a physical defect of the probe head, such as an uneven, scratched, or chipped probe head. In many implementations, more than one condition indicator may be determined for a particular captured image. Many implementations can also include determining a particular condition indicator for multiple captured images.

Some disclosed methods include capturing a sequence of images of a probe head and constructing time-series data using the sequence of captured images to extract a feature (or features) from respective images of the sequence of captured images. The extracted feature(s) can be analyzed corresponding to the respective images to determine data associated with a condition indicator over time. Additionally, a respective defect score may be generated corresponding to one or more respective images of the sequence of captured images. Furthermore, a degradation index can be determined, based on the time series data, such as a degradation index quantifying a rate of degradation for the probe head over time. In one implementation, a remaining useful life (RUL) metric is predicted for the probe head based on the degradation index.

One disclosed implementation also includes a method of capturing an image of a probe head using an imaging device, processing the captured image using an image processing model to extract a feature of the captured image of the probe head, analyzing the extracted feature of the other captured image to determine a condition indicator for the probe head, and generating a defect score based, at least in part, on the determined condition indicator. A quality record can be logged for the probe head, and the quality record can include a timestamp and data identifying at least one of the extracted features, the determined condition indicator, and the generated defect score. In some disclosed implementations, a captured image may be processed in order to generate at least one of a plurality of data records for a probe head, such as a nonconformance record and/or a quality record. For example, a quality record may be logged in a data log associated with a captured image, and a nonconformance record may only be logged if the defect score associated with the captured image satisfies a pre-determined threshold. Alternatively, a quality record (or, analogously, a conformance record) may be logged when the defect score does not satisfy the pre-determined threshold. A nonconformance record may be logged within, or in association with, a quality record. Nonconformance records and quality records may be stored in separate respective data logs, or a shared data log.

In some implementations, a defect score can be evaluated based on two or more pre-defined thresholds stored in a memory. A respective pre-defined threshold of the two or more pre-defined thresholds may be defined based on one or more of: a particular feature, a particular condition indicator, a particular defect score value, a service lifetime of the probe head, and/or a timestamp of the captured image of the probe head. A nonconformance record for the probe head may further include data identifying at least one pre-defined threshold, of the two or more pre-defined thresholds, that is satisfied by the generated defect score. A quality record and/or nonconformance record may also include data identifying at least one pre-defined threshold, of the two or more pre-defined thresholds, that is not satisfied by the generated defect score.

Another disclosed method includes receiving a probe measurement, determining a corrective adjustment based, at least in part, on the defect score, and generating a corrected probe measurement based on the probe measurement and the corrective adjustment. The probe measurement can be obtained by the probe head at a timestamp that lies within a pre-defined window of tolerance relative to the timestamp of the captured image. In yet another disclosed method, the capturing of the image of the probe head is triggered by an image capture trigger criterion. The image capture trigger criterion can be based on at least one of: a pre-defined time interval between respective captures, a pre-defined quantity of measurements obtained by the probe head between respective captures, a detection that a work product has been loaded onto a sample measurement area associated with the probe head, a detection that the work product has been unloaded from the sample measurement area associated with the probe head, a detection that the probe head is idle, and/or a detection that the probe head is obtaining a measurement.

Various systems are disclosed including one or more processors coupled to memory, the memory being loaded with computer instructions that, upon execution by the processors, implement one or more operations included within any of the methods disclosed herein. Some implementations also relate to a non-transitory computer readable storage medium storing computer program instructions that, upon execution by a processor, implement one or more operations included within any of the methods disclosed herein. Other implementations are described further throughout the detailed description.

### BRIEF DESCRIPTION OF THE DRAWINGS

The invention will be described with respect to specific implementations thereof, and reference will be made to the drawings, which are not drawn to scale, and in which:

FIG. 1 illustrates an example monitoring system configured to evaluate the condition of a probe head used in a probe-based measurement system, according to an embodiment of the present disclosure.

FIG. 2A illustrates a message flow diagram for a defect monitoring workflow, representing an example implementation including the monitoring system capturing data and evaluating data reflecting the condition of a probe head, according to an embodiment of the present disclosure.

FIG. 2B illustrates a message flow diagram for a notification workflow, representing an example implementation including the monitoring system generating a notification reflecting the condition of a probe head, according to an embodiment of the present disclosure.

FIG. 2C illustrates a message flow diagram for a measurement correction workflow, representing an example implementation including the monitoring system generating corrected measurement data with respect to a probe head, according to an embodiment of the present disclosure.

FIG. 3 is an example vision module circuit, in accordance with one implementation of the technology disclosed, according to an embodiment of the present disclosure.

FIG. 4 depicts an illustrative example of progressive degradation of a probe head across multiple timepoints, and how such degradation may be assessed using various image-derived defect scoring strategies, according to an embodiment of the present disclosure.

FIG. 5 provides an example of real-world data that serves as objective indicia of non-obviousness supporting the technology disclosed herein, according to an embodiment of the present disclosure.

FIG. 6 illustrates a block diagram of a computer system that can be used to implement the technology disclosed, according to an embodiment of the present disclosure.

### DETAILED DESCRIPTION

The following detailed description is made with reference to the figures provided below. Example implementations are described to illustrate the technology disclosed, not to limit its scope, which is defined by the claims. Those of ordinary skill in the art will recognize a variety of equivalent variations on the description that follows.

Probing systems, such as mercury probes, are routinely used to measure the electrical characteristics of semiconductor wafers, thereby providing critical insight into material properties and production quality. However, the accuracy of these measurements is directly tied to the condition of the probe head. Over time, the surface of the probe head degrades due to contamination and wear from repeated use. Common contaminants like silicon carbide spikes and residual chemicals accumulate gradually, interfering with the electrical interface between the probe and the wafer. As degradation progresses, measurement results become increasingly noisy, drift, or inconsistent, undermining the reliability of production data and quality assurance processes. Implementations of the technology disclosed provide timely, objective data-driven insights on probe health, therefore allowing probing system operators and manufacturers to reduce downtime, avoid costly damage to work products, and extend the life of expensive probing equipment. The disclosed automatic probe monitoring systems and methods transform probe monitoring from an art into a science by introducing a quality assurance strategy that is proactive, consistent, and efficient. Many implementations of the technology disclosed improve operational reliability while aligning with broader industry trends towards informed manufacturing and automated process control in a world that is increasingly dependent on high quality semiconductor fabrication.

Despite the risks associated with probe head degradation, semiconductor manufacturers lack an efficient way to assess probe integrity. Existing inspection procedures rely on manual disassembly of the probing system and visual inspection of the probe head under a microscope. This process is slow, subjective, and requires forced downtime from production. It is difficult to determine when a probe begins to fail without performing the manual inspection process. As a result, operators are faced with an ongoing tradeoff-inspect too frequently at the risk of wasting time, labor, and materials, or inspect too infrequently and risk wafer damage, scrapped product, and compromised data integrity. Replacement of the entire probe stage, which hosts the probe head, in a mercury probe system can cost between $10,000-$20,000 USD, and many new systems are designed to include a replaceable probe head, which could cost between $1,000, $2,000 USD, to mitigate maintenance costs by reducing the risk of damage to the more expensive underlying probe stage. Replaceable probe heads are intended to be replaced more frequently at a lower cost, compared to replacement of the entire probe stage.

While the use of replaceable probe heads can help mitigate some of the consequences of probe head degradation, as they can be replaced and sometimes can be repaired and reused in the same probe stage. Replaceable probe heads alone do not offer a complete solution. They cannot prevent the “cross damage” effect generated from the contamination or defects, such spike defects of silicon carbides, on the probe head, which is subsequently used to measure the next clean wafer and which caused the damage of the clean wafer. As a result, inspections of the probe head are much necessary. Moreover, because there is no reliable way to predict when a probe head will begin to fail, determining an appropriate inspection schedule remains a significant challenge. The replacement cost of a probe head is less than the replacement cost for the full probe stage, but costs can still accumulate rapidly if replacements and repair of the probe head are performed too often. Importantly, the most significant cost associated with probe maintenance (whether through probe head replacement, inspection, or both) is often not the direct material cost of the replacement parts, but the loss of materials, e.g., wafers and production downtime that occurs whilst maintenance tasks are carried out. These losses translate directly into lost profits, leading many manufacturers to err on the side of under-inspection, accepting higher risk in exchange for uninterrupted throughput.

The consequences of a degraded probe head may not be visible until costly damage has already occurred to the probe head itself, and defective wafers, which could be due to “cross damage” effect, have already progressed further into the production pipeline. As semiconductor devices become increasingly foundational to modern technology, including within sectors ranging from consumer electronics to automotive safety and national infrastructure, the demand for high-throughput, high-integrity manufacturing pipelines expands at an exponential rate. Even minor deviations in process control can cascade into large-scale product losses and missed production targets. Despite this growing importance, standard practices for probe head inspection have not kept pace with the increasing demands of modern semiconductor fabrication, particularly with respect to traceability, automation, and predictive maintenance.

Use of computer vision for the inspection of final work products (e.g., completed wafers or packaged chips) is becoming increasingly common, but comparatively little attention has been paid to monitoring the condition of production equipment itself, like the probe systems used to evaluate semiconductor wafer quality. This oversight leaves a blind spot in production, because downstream inspection of work products may help to discover errors related to probe degradation, but this fails to address or prevent the upstream degradation itself. As a result, problems caused by probe head degradation or contamination may only be identified after they've already affected product quality, consequently triggering reactive, time-intensive intervention and costly rework.

Accordingly, there is a need for proactive, data-driven probe head monitoring involving treating the probe head itself as a subject of quality assurance, rather than relying solely on predictive guesswork or indirect downstream indicators that a failure has already occurred. It is desirable for said probe head monitoring to integrate seamlessly into production environments, operate without disrupting normal workflows, and prove objective, prescriptive information about the probe head's condition to better support informed decision-making and predictive maintenance strategies.

The technology disclosed addresses this unmet need by providing an integrated, image-based monitoring system that automatically inspects the probe head without interrupting normal system operation. A compact, high-resolution camera integrated within the probing framework can capture images of the probe head at regular intervals (e.g., every time right before a wafer is measured) to provide consistent, standardized visual image and data. The captured images can be analyzed using a computer vision pipeline to detect various probe head defects, such as silicon carbide buildup (“spikes”) and chemical residue. The disclosed system can generate a quantitative defect score from the captured images and leverage the quantitative defect score as a proxy for probe head health, thereby allowing operators to track degradation trends over time with precision and objectivity.

Unlike manual inspection processes, which can vary inconsistently between users and require significant time and expertise, the disclosed system and methods offer objective reproducible outputs in under one second. The disclosed system passively monitors the probe head status during its normal operation without requiring shutdown or disassembly, offering practical deployment within a production environment. The use of defect scoring further enables manufacturers to configure customizable thresholds tailored to their own operational tolerances, and the thresholds can subsequently be leveraged to trigger warnings or alarms when a probe is showing signs of degradation or degradation is predicted to occur in the near future. Quality control thresholds can be pre-determined at a manually set value, or experimentally determined. For example, threshold value(s), range(s), and/or constraints can be experimentally determined from calibration using controlled samples (e.g., constructing a reference curve from a set of probe heads ranging from pristine to heavily damaged) or a curated set of real-world data captured in a shadow mode during normal operation. Customization of thresholds for specific use case applications allows operators to refine the probe head monitoring system based on scoring criteria that reflects contextually-relevant real world considerations. Said protocol refinement consequently further mitigates the risk of either overly reactive or excessively lax maintenance protocols resulting from generic or arbitrary quality control guidelines.

The disclosed system and methods offer a wide range of applicability that is not limited to the identification of a single type of defect or contamination. A broad set of anomalies, including new or unexpected anomalies, can be identified from the captured image data as more data is collected and correlations are identified within the data that link certain probe head features detected within the images and probe head integrity/performance characteristics determined for the probe head. Hence, the disclosed systems and methods offer a forward-compatible tool that reflects a shift from static rule-based inspection towards dynamic, data-driven probe head monitoring. Moreover, ongoing data collection can be leveraged to continuously support and fine-tune predictive maintenance models capable of estimating remaining probe life or enabling earlier-stage error detection based on improved pattern recognition as more data becomes available.

Many implementations of the technology disclosed offer strategies for probe head inspection, defect quantification, and equipment quality control characterized by passive and near-real time functionality. The disclosed probe head monitoring system can continuously monitor the status and integrity of a probe head while the probe head is concurrently deployed in a production environment without interfering with the normal functioning of the probing system. Moreover, many disclosed probe head monitoring workflows (including capturing image data for a probe head, processing the image data to evaluate probe head integrity and detect probe head defects, and generating an output score quantifying probe head degradation) can be completed in under one second. The near-real time generation of actionable information related to probe head status effectively enables the prevention of unnecessary further damage caused by otherwise unnoticed defects and reduces the need for post-damage reactive correction.

In contrast to computer vision-based systems for quality assurance focused on a completed product, which are inherently reactive by nature, the technology disclosed relates to an innovative and novel alternative that applies computer vision to address a longstanding pain point in semiconductor wafer production with respect to the expensive consequences placed at risk, including the subjective, inefficient, and/or imprecise guesswork often involved in probe head maintenance and the expensive quality assurance focused on earlier detection of faulty probe head operation. Thus, the technology disclosed offers a proactive solution involving real time probe head monitoring, early fault detection, and the generation of prescriptive analytics and data insights to better inform protocol development.

### System Overview

The technology disclosed relates to an image processing system that automatically monitors the condition of a probe head used in a probing measurement system, detects defects of the probe head, and leverages data captured about the probe head to generate prescriptive outputs that can improve quality control protocols. In contrast to traditional quality control protocols in manufacturing pipelines that focus on evaluating the quality of the completed work product itself, the disclosed system offers a proactive solution that detects potential defects before they occur, mitigating the risk of further defect-related damage. Many implementations of the technology disclosed relate to a probe monitoring system that decreases the overall cost of poor quality (COPQ) by employing passive field monitoring (e.g., evaluating the status of a probe head without interrupting normal operation of the probe head, thereby reducing costs from downtime), early defect detection (e.g., detecting that a probe head contains defects on a seconds timescale and addressing the defect before the defective probe head can potentially damage additional work product), and offering a structured, data-informed approach to probe head maintenance that prevents lost profits by overperforming or underperforming maintenance tasks.

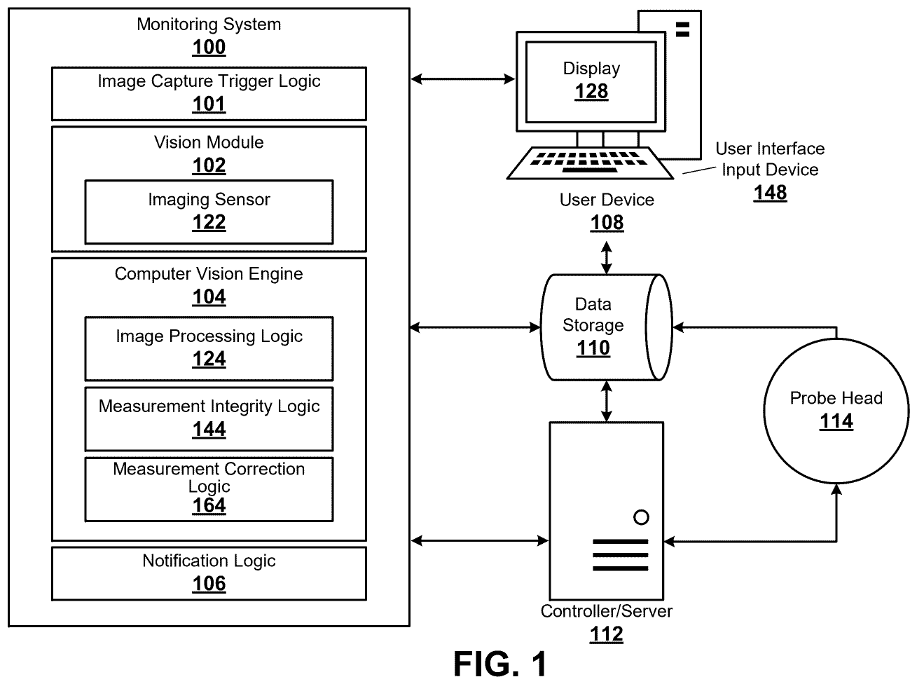

A system and various implementations of the subject technology are described with reference to FIGS. 1-6. The system and processes are described with reference to FIG. 1, an architectural level schematic of a system in accordance with one example implementation. Because FIG. 1 is an architectural diagram, certain details are omitted to improve the clarity of the description.

The description of FIG. 1 is organized as follows. First, a summary of FIG. 1 will be introduced, including describing the elements of the system and their interconnections. Next, the elements of FIG. 1 are described in greater detail.

FIG. 1 illustrates an example monitoring system 100 configured to evaluate a condition of a probe head 114 used in a probe-based measurement system. The condition may be particle build-up, for example, or another condition that impacts the overall performance and quality of the probe measurements. The monitoring system 100 may be implemented in connection with any suitable probe-based characterization tool, including mercury probe systems, four-point probes, or other metrology tools that physically contact a sample surface during operation. While the depicted implementation is directed to inline monitoring of a mercury probe system, variations are contemplated across different probing technologies and industrial environments.

Monitoring system 100 includes an image capture triggering logic 101, a vision module 102, a computer vision engine 104, and a notification logic 106. The vision module includes an imaging sensor 122, such as a camera. Computer vision engine 104 includes one or more subcomponents such as image processing logic 124, measurement integrity logic 144, and/or measurement correction logic 164. These components may be integrated within a single device, distributed across multiple local or network-connected components, or combined with functionality of an existing host control system. Communication between these components may be implemented via wired or wireless communication interfaces, buses, or signal pathways. The respective subcomponents of system 100 illustrated in the example implementation of FIG. 1 will be discussed in further detail below, following a discussion of the remaining elements of FIG. 1.

### Probing System

FIG. 1 further includes a probe head 114, controller/server 112, data storage 110, and user device 108. In many implementations of the technology disclosed, probe head 114 is part of a mercury probe system configured to perform electrical characterization of a substrate. Mercury probe systems are commonly used in semiconductor manufacturing and research to measure parameters such as sheet resistance, doping profiles, junction depth, and dielectric integrity without the need for permanent metallization or lithographic patterning. The mercury probe head 114 enables non-destructive contact with the surface of a wafer or substrate using a precisely controlled amount of mercury as the electrical contact medium.

The probe head 114 typically includes one or more microcapillaries, needles, nozzles, columns, or similar reservoirs that dispense mercury onto the surface of the wafer. A precisely formed mercury droplet is brought into contact with the sample under defined force and alignment parameters. The system then applies a voltage and measures the resulting current to extract material properties. Some probe heads use single-dot contact for vertical capacitance-voltage (C-V) measurements, while others use dual-dot or ring-dot configurations to support spreading resistance or lateral resistivity tests. The probe head 114 may belong to a mercury probe system or four-point system similar to those described in commonly-owned U.S. Pat. No. 6,435,045 issued 20 Aug. 2002, titled “Apparatus and Method for Automatically Changing the Probe-Head in a Four-Point Probe System,” and commonly-owned U.S. Pat. No. 7,253,649 issued 7 Aug. 2007, titled “Automatic Mercury Probe for Use With a Semiconductor Wafer,” both of which are fully incorporated by reference herein for all purposes.

Because the mercury comes into direct contact with both the probe head and the wafer, surface cleanliness and mechanical integrity of the probe head 114 are critical for measurement accuracy and wafer safety. Over time, contaminants such as silicon carbide particles, metallic residues, or organic films may accumulate on the probe head surface. Additionally, mechanical wear or misalignment may lead to nonuniform contact pressure, droplet deformation, or unintended wafer scratching. To reduce the risk of damaging either the probe head or the wafer under test, systems may include a replaceable probe head. It can be removed or replaced without disassembling the full probe structure. Replaceable probe head are typically made from chemically inert materials and are designed to withstand repeated thermal and mechanical cycles.

Maintenance of the probe head 114 may involve routine inspection, cleaning, or probe head replacement. Cleaning processes can include manual wiping with lint-free swabs, solvent rinsing (e.g., with isopropyl alcohol or acetone), plasma cleaning, or ultrasonic agitation. Maintenance schedules vary depending on usage frequency, wafer material, environmental exposure, and contamination severity. Improper or delayed maintenance can lead to inaccurate measurements, probe failure, or wafer damage. Full replacement of the probe head assembly may be required if mechanical tolerances are exceeded, contact surfaces become damaged, or internal actuation mechanisms fail. In many probe systems, probe head replacement can require system shutdown and recalibration, resulting in production downtime.

In alternative implementations, the probe head 114 may correspond to other probe types, such as a four-point probe used to measure sheet resistance through collinear metal tips that apply current and sense voltage. In another example implementation, the probe head 114 may be part of a microprobing station, such as those used in die-level electrical testing. In yet other implementations, the probe head 114 may form part of a stylus-based profilometry system, where the “probe” physically drags or taps across the sample to measure surface topology. In this case, degradation may involve stylus blunting, debris accumulation, or coating wear, which can similarly be detected via image-based analysis techniques as described with respect to the monitoring system 100.

For clarity, many implementations described herein are described with respect to a mercury probing system. However, most implementations of the technology disclosed relate to probe head 114 that represents a wear-sensitive, contamination prone component of a measurement instrument, with a surface integrity that directly impacts measurement reliability and output yield. The monitoring system 100 provides a non-invasive, automated mechanism for evaluating the probe head's condition over time, thereby enabling early detection of defects, predictive maintenance scheduling, and reduced risk of device failure or wafer loss.

FIG. 1 also includes the controller 112 (also referred to in some implementations as a host controller, central control unit, server, or process controller). Controller 112 can be configured to manage coordination and operation of the probe-based measurement system, including the probe head 114, the image capture subsystem, and/or the various monitoring and notification components described herein. The controller 112 may be implemented as an integrated component of the probing tool itself or as an external computing device in communication with the system via wired or wireless network protocols. In many implementations, the controller 112 serves as the primary interface between the measurement system and external systems or operators. For example, in the context of a mercury probe system, the controller may be responsible for positioning and actuating the probe head 114, controlling the application of electrical bias, managing timing and measurement sequences, and logging measurement results. The controller may also coordinate motion control elements, safety interlocks, and environmental control features such as temperature regulation or vacuum chamber operation.

Because the controller 112 may be implemented in different hardware and software configurations across manufacturing environments, it is not limited to a specific physical form or processing architecture. The functionality described may be executed on a single processor or distributed across multiple coordinated systems. In some configurations, portions of the controller functionality (e.g., threshold comparison or user interface management) may be offloaded to cloud-based services or embedded microcontrollers within the probe system hardware.

The monitoring system 100 and/or controller 112 may further interface with at least one user device 108. User device 108 may be a local operator terminal integrated into the probing tool enclosure, a remote workstation, a networked desktop or laptop computer, a touchscreen panel, a tablet, or any other computing device capable of receiving and displaying information from the system. In some implementations, the user device 108 may be a web-enabled interface or mobile device in communication with the system through a secure local or cloud-based connection. In some implementations, multiple user devices 108 interface with the monitoring system 100, controller 112, and/or data storage 110. Generally speaking, user device 108 is an addressable hardware device or virtual device that is attached to a network, and is capable of sending, receiving, or forwarding information over a communications channel to or from other end points. Examples of electronic devices which can be deployed as user device 108 include all varieties of computers, workstations, laptop computers, handheld computers, and smartphones. User device 108 can be implemented in a cloud-based server system and/or a local system. More than one virtual device configured as a user device 108 can be implemented using a single physical device.

The user device 108 may include a display 128, such as an LCD, LED, OLED, or other graphical interface configured to present condition indicators, defect scores, visual summaries of image data, historical trends, system status alerts, and maintenance recommendations. The display 128 may be configured to present a graphical user interface (GUI) with interactive controls and visualization elements. In some implementations, the user device 108 also includes user input hardware 148 such as buttons, a keyboard, a mouse, a touch-sensitive surface, or voice control features, enabling an operator to acknowledge alerts, adjust thresholds, view additional data, initiate corrective actions, or override automated decisions. In various implementations, the user device 108 may be physically separate from the probe tool or integrated into the host control system, and may provide role-based access for operators, technicians, engineers, or quality assurance personnel. The user device 108 may additionally support communication with upstream systems such as manufacturing execution systems (MES), laboratory information management systems (LIMS), or plant-wide monitoring dashboards.

The data storage 110 comprises one or more memory or storage components configured to store image data, extracted image features, condition indicators, defect scores, threshold values, user preferences, and system logs. Data storage 110 can be stored on one or more non-transitory computer readable media. As used herein, no distinction is intended between whether a database is disposed “on” or “in” a computer readable medium. Additionally, as used herein, the term “database” does not necessarily imply any unity of structure. For example, two or more separate databases, when considered together, still constitute a “database” as that term is used herein. Thus, data storage 110 may comprise multiple databases or storages. Storage 110 may be located within a local memory (e.g., solid-state drives, hard drives, RAM), network-attached storage (NAS), or cloud-based infrastructure, for example. In some implementations, the storage component may be physically located within the controller 112 or user device 108, while in other configurations, it may be hosted externally or partitioned across multiple locations.

The data stored in data storage 110 may be indexed or linked to metadata such as timestamps, wafer identifiers, probe tool serial numbers, lot or batch codes, or environmental conditions. The system may implement storage retention policies, access controls, or audit logs to support quality assurance, regulatory compliance, or retrospective analysis. The roles of the user device 108 and the data storage 110 within the context of monitoring system 100 will be described in further detail in connection with the functionality of other system elements, including the image capture operation, condition indicator generation, notification workflows, and user interaction procedures.

Details of the monitoring system 100 and the various types of processing engines/logics that can be included within monitoring system 100 are presented below. These engines and/or logics can comprise various devices that implement instructions to perform operations related to the monitoring of probe head integrity. A device (or an engine) described herein can include one or more processors. The ‘processor’ comprises hardware that runs a computer program code. Specifically, the specification teaches that the term ‘processor’ is synonymous with terms like controller and computer and should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry.

### Automatic Probe Monitoring System

The individual components of monitoring system 100 will now be described in further detail, beginning with the vision module 102, followed by a discussion of the computer vision engine 104 and notification logic 106.

### Vision Module

The vision module 102 can include an imaging sensor 122 for acquiring visual data (e.g., an image) of the probe head 114, thereby enabling automatic inspection of the probe head status without requiring probe disassembly or disruption of its measurement operation. Vision module 102 enables the monitoring system 100 to evaluate the condition of the probe head (e.g., at rest, between measurement cycles, or during wafer transitions) by analyzing images of the probe head surface to extract quantifiable features, generate condition indicators used to assess the integrity of the probe surface, detect signs of degradation, and inform maintenance decisions.

The image sensor 122 may be implemented using a variety of imaging technologies depending on the particular application and desired resolution, sensitivity, and integration requirements. In one example, the image sensor 122 is a digital monochrome or color camera, such as a CMOS or CCD sensor, mounted in a position that provides a clear view of the probe head surface. The sensor may be configured to capture images at defined intervals, upon specific triggering events (e.g., wafer unload), or continuously during idle periods between probe operations, as discussed further below with respect to image capture trigger logic 101. In some implementations, the image sensor 122 may operate in conjunction with a ring light or diffuse backlight to enhance image contrast and eliminate shadows or reflections that could obscure surface anomalies.

In many implementations, the image sensor 122 may comprise a three-axis (3-axis) camera system. In this implementation, the x- and y-axes may be used to center the camera precisely over the probe head or to acquire a tiled image of a larger probe surface, while the z-axis provides controlled focal adjustment to compensate for height variation or to focus on particular layers or features of the surface. Autofocus routines or calibrated focus maps may be employed to ensure consistent image quality across multiple capture events. In other implementations, alternative sensor technologies may also be used depending on the type of degradation being monitored. For example, an infrared (IR) imaging sensor may be used to detect thermal signatures associated with probe head overheating or damage. A hyperspectral imaging sensor may be employed to detect chemical residues or thin film contamination that are difficult to resolve using visible light. In some implementations, a structured light sensor or low-magnification microscope may be used to detect surface irregularities, scratches, or deposited particles.

In other implementations, different kinds of sensors can be used to produce sequences of images (or representations). Examples of such sensors include ultrasound sensors, thermal sensors, and/or LiDAR, ultra-wideband sensors, depth sensors, etc., which are used to produce sequences of images (or representations) of a probe head surface. In one implementation, sensors can be used in addition to the 3-axis camera. Multiple sensors can be synchronized in time with each other, so that frames are captured by the sensors at the same time, or close in time, and at the same frame capture rate (or different rates). All of the implementations described herein can include sensors other than or in addition to the 3-axis camera.

The vision module 102 may include preprocessing logic to normalize brightness, adjust contrast, or apply digital corrections for lens distortion and focus anomalies. Masking logic may be used to isolate relevant regions of interest (ROI) on the probe head surface, and/or exclude surrounding mechanical structures or background elements from analysis. In some implementations, the vision module may extract a subset of image data or metadata to reduce processing load or bandwidth requirements for subsequent analysis by the computer vision engine 104. The imaging process is designed to operate without interfering with the functional operation of the probe head. In many implementations, images may be captured during transitional phases of the probe cycle, e.g., after a wafer is removed but before a new wafer is loaded, or during brief idle states in between measurement sequences. Because the inspection is visual and non-contact, no probe retraction, power-down, or tool downtime is required to perform the monitoring. This allows for seamless integration of the image capture system into high-throughput manufacturing environments, minimizing disruption while still enabling effective condition tracking.

The images captured by image sensor 122 provide a basis for condition assessment by capturing visible evidence of degradation such as dark particulate accumulations, light scatter patterns, scratches, or surface deformations. These features are further processed and interpreted by the image processing logic 124 and the computer vision engine 104, as described in subsequent sections. A feature extracted from the captured image can be an anomaly detection feature, for example. The anomaly detection feature can be based on one or more attributes, such as an anomalous feature detection variable, an anomaly classification variable, an anomaly frequency variable, an anomaly localization variable, an anomaly size variable, and/or an anomaly class density variable. Anomaly detection variables are described in further detail with reference to the image processing logic 124.

The ability of the image sensor 122 to capture consistent, high-quality images of the probe head surface without interfering with probe head operation is enhanced by the inclusion of image capture trigger logic 101. The image capture trigger logic 101 is configured to determine when the image sensor 122 should capture an image, e.g., based on at least one image capture trigger criterion. The image capture trigger criteria can include one or more time-based intervals, event-based signals, measurement activity, or combinations thereof. For example, the image capture trigger criteria can be based on one or more of a pre-defined time interval between respective captures, a pre-defined quantity of measurements obtained by the probe head between respective captures, a detection that a work product has been loaded onto a sample measurement area associated with the probe head, a detection that the work product has been unloaded from the sample measurement area associated with the probe head, a detection that the probe head is idle, and/or a detection that the probe head is obtaining a measurement. By coordinating the timing of image acquisition with appropriate system states, the image capture trigger logic 101 enables the monitoring system 100 to capture diagnostically useful images without disrupting ongoing wafer testing or requiring operator input.

In some implementations, the image capture trigger logic 101 initiates image capture at fixed time intervals, such as every 30 minutes, hourly, or once per shift. In various implementations, the time interval in between captures can be a length of time within the inclusive range between 1 and 60 minutes, or between 1 and 24 hours. This configuration may be suitable for lower-throughput environments or baseline monitoring, for example. In alternative implementations, the trigger logic may be configured to initiate image capture based on a count of measurement events, such as every 10, 25, 50, or 100 probed wafers. These values may be preconfigured, operator-defined, or dynamically adjusted based on historical degradation trends. In other implementations, the image capture trigger logic may rely on event-based triggers, such as completion of a probe cycle, detection of water loading or unloading, a change in environmental conditions (e.g., based on a temperature or humidity threshold or tolerance range), or anomalies in recent measurement results, such as an elevation in variance or nonconforming data.

The image capture trigger logic 101 may also be integrated with the controller 112 and configured to operate conditionally, such that image capture occurs only if specific system states are satisfied. For example, an image may be captured only when no wafer is currently present on the sample platform, or when the probe head is in a parked or idle position. To further reduce unnecessary data collection and optimize resource use, the image capture trigger logic 101 may include a rule-based scheduler. For example, the system may defer image capture if the previous image showed no signs of degradation, or may increase the capture frequency when degradation trends are detected. In some implementations, image capture timing may also be responsive to feedback from the computer vision engine 104, enabling adaptive scheduling based on real-time analysis results.

The output of the image capture trigger logic 101 may be a command signal transmitted to the imaging sensor 122 and/or the vision module 102, initiating the acquisition process. This design allows the monitoring system to function in a largely autonomous fashion, with no need for operator-initiated inspections, and without requiring the probing system to pause, retract, or otherwise alter its normal operation. By capturing images at strategically selected times aligned with probe system behavior and measurement throughput, the image capture trigger logic 101 aids in enabling proactive, continuous monitoring of the probe head condition in a non-intrusive and production-compatible manner.

### Computer Vision Engine

Once an image of the probe head surface has been acquired by the image sensor 122, it is provided to the computer vision engine 104 for analysis. The computer vision engine 104 is configured to evaluate the visual data and generate one or more condition indicator(s) and defect score(s) that reflect the operational state of the probe head 114. This evaluation may involve multiple processing stages, including image preprocessing, feature extraction, classification, defect scoring, and in certain implementations, measurement correction. The computer vision engine 104 may be implemented using software, firmware, or hardware logic, and may execute locally within the probe system, remotely on a networked server, or across distributed compute resources.

In many implementations of the computer vision engine 104, the image processing logic 124 is responsible for analyzing raw or preprocessed image data to extract one or more features that serve as the basis for downstream condition evaluation. The image processing logic 124 may employ any of a variety of conventional or custom image analysis techniques to transform visual information into quantitative data describing the appearance and structure of the probe head surface.

In one example implementation, the image processing logic 124 can segment the captured image to isolate regions of interest (ROIs), such as dark particles, reflective streaks, surface residues, or other artifacts indicative of wear or contamination. Segmentation may be performed using intensity thresholding, edge detection, morphological filters, contour detection, blob detection, or a combination of such techniques. Preprocessing steps such as Gaussian blur, histogram equalization, or adaptive thresholding may be used to enhance contrast and improve segmentation robustness under variable lighting or background conditions. Once regions of interest are identified, the image processing logic 124 may extract one or more of region-based and boundary-based features, including but not limited to: area/surface area (e.g., total pixel count of a segmented feature), count (e.g., number of detected features above a certain size or contrast threshold), shape descriptors for identified objects of interest (e.g., aspect ratio, major/minor axis length, eccentricity, convexity, circularity, etc.), intensity-based descriptors (e.g., mean pixel intensity, standard deviation, contrast relative to surrounding areas, and other related edge-detection parameters), and/or spatial distribution metrics (e.g., feature clustering, orientation, location relative to probe surface center, etc.).

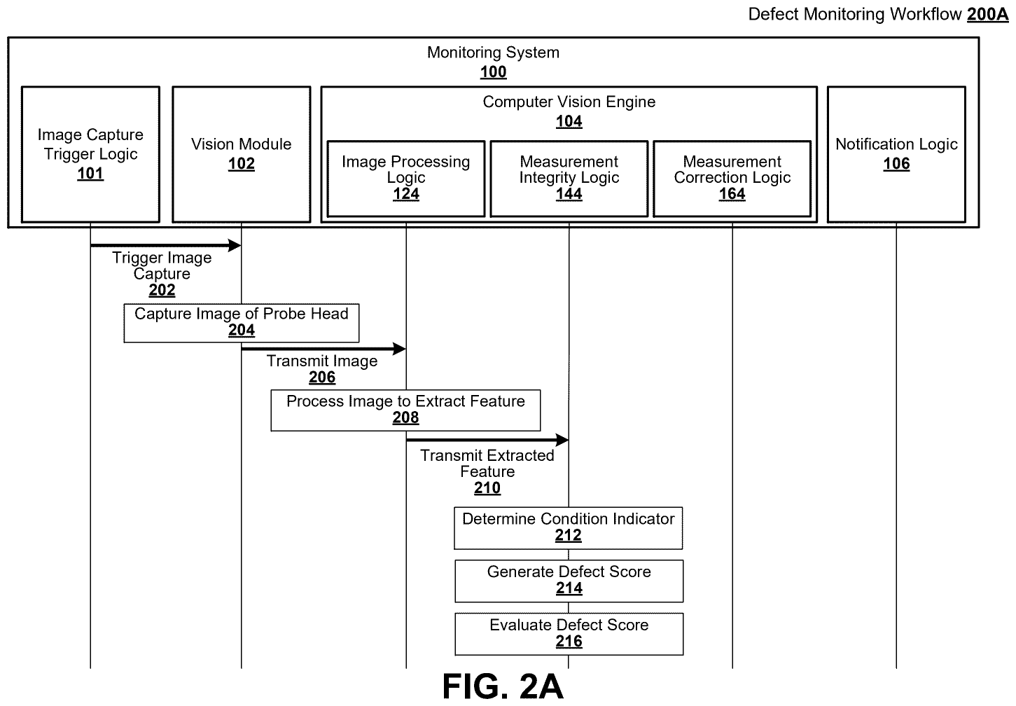

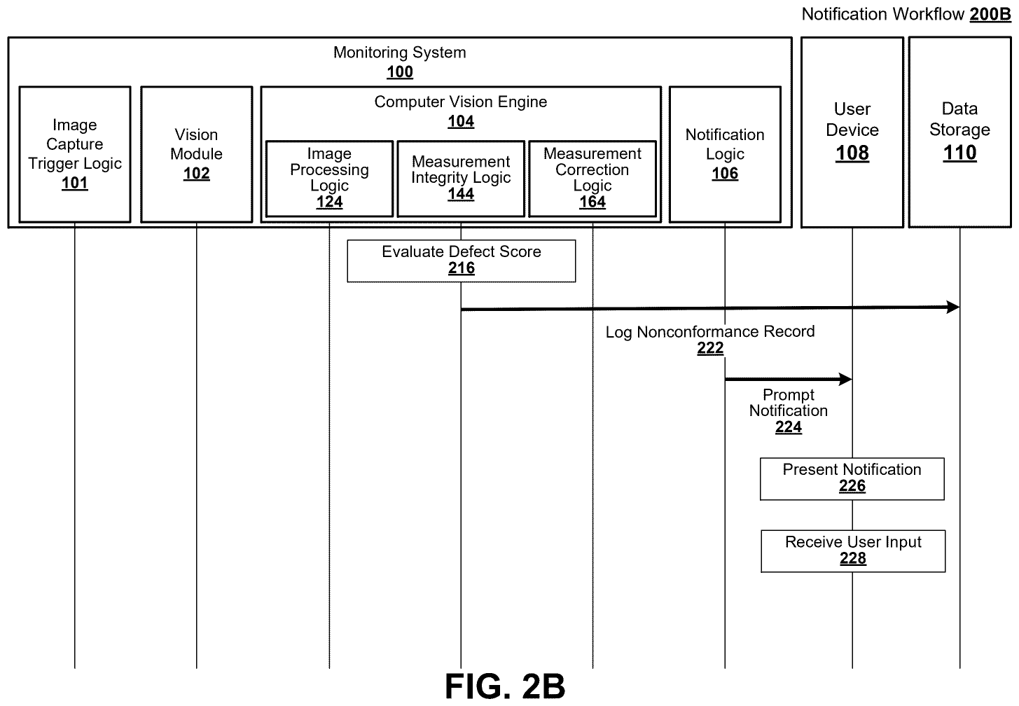

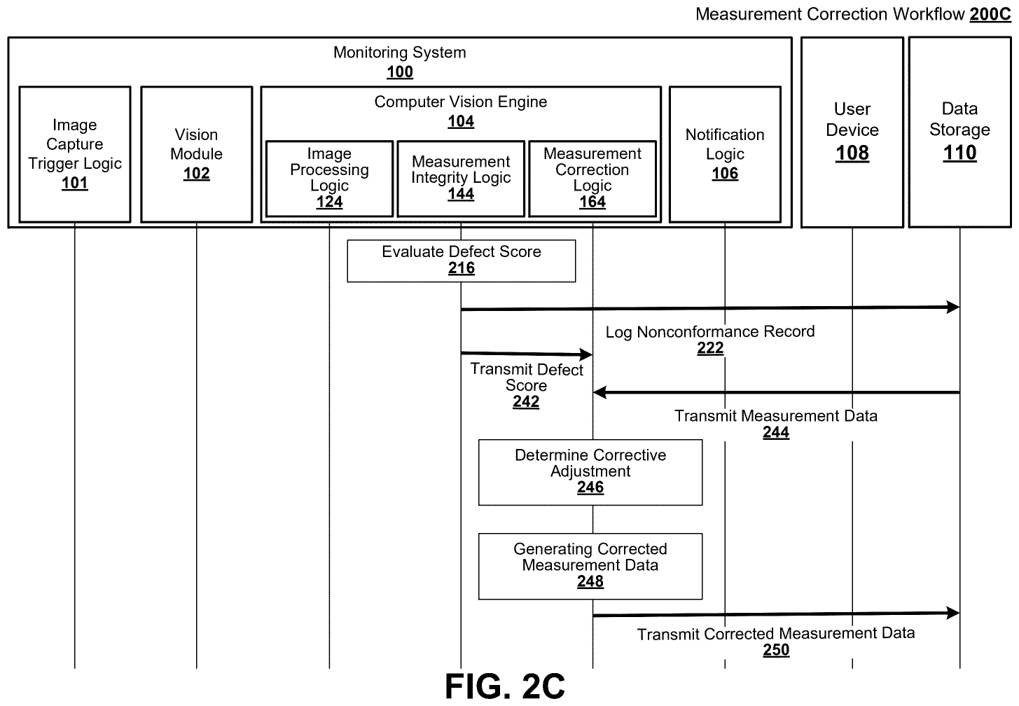

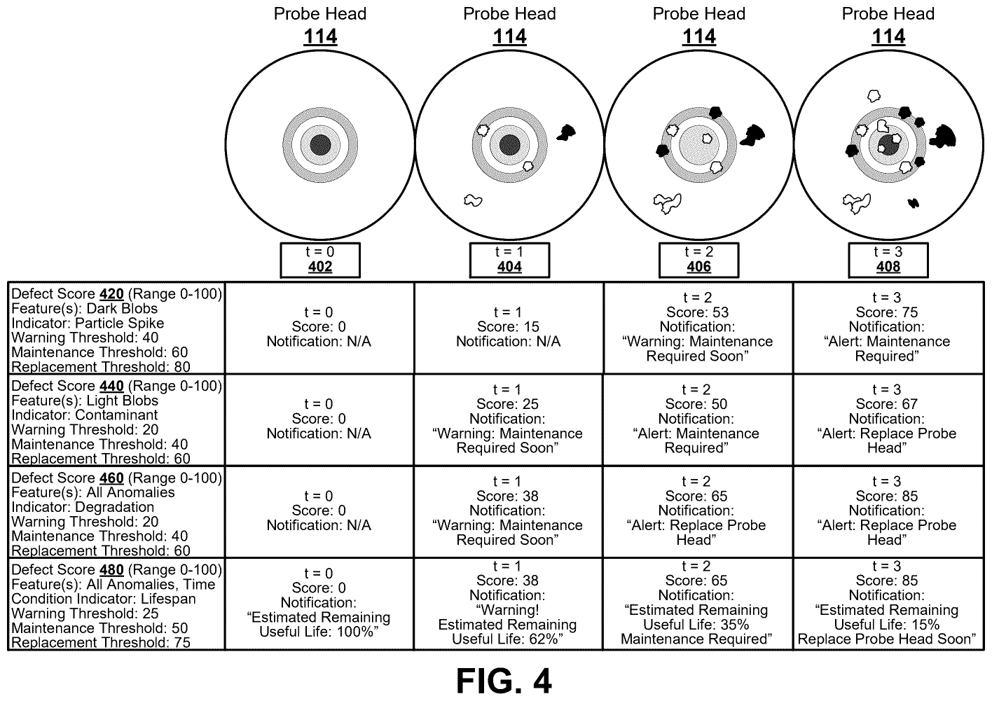

In many implementations, the one or more extracted features are anomaly detection features based on one or more attributes, such as a particular anomaly detection variable. For example, an anomalous feature detection variable can identify one or more anomalous features detected within at least a portion of the captured image. An anomalous feature may be a signal intensity, a contrast, a brightness, a boundary attribute, a region attribute, or other attributes described above and similar attributes. In another example, an anomaly classification variable identifies one or more anomaly classes detected within at least the portion of the captured image, wherein the one or more anomaly classes identified by the anomaly classification variable are determined based, at least in part, on the anomalous features identified in association with the anomalous feature detection variable. In some examples, different types of anomalous features can be linked to different types of defects due to differing optical characteristics associated with respective defects. In one example, the presence of non-metal particles (e.g., silicon carbide) may be distinct from the presence of metallic particles (e.g., mercury) based on differing physical properties that influence how the particle interacts with light. In one implementation, the anomalous feature detection variable may identify anomalous features related to dark spots or “blobs” on the surface of the probe, and the anomalous classification variable may include data identifying the dark blob anomalous features as representing anomalies related to a non-metal particle build-up anomaly like a silicon carbide spike. Other example anomaly classes are described further with respect to FIGS. 2A and 4.

In another example, an anomaly frequency variable quantifies a count of one or more anomalies detected within at least the portion of the captured image. In yet another example, an anomaly localization variable identifies a location of an anomaly detected within at least the portion of the captured image, wherein the location of the anomaly is defined relative to a surface area of the probe head visible within the captured image (e.g., distance from the center of the probe head surface). In another example, an anomaly size variable quantifies a size of an anomaly detected within at least the portion of the captured image, wherein the size of the anomaly is determined based on one or more of a diameter, a width, a length, a bounding box, and/or a surface area. The attribute can also be an anomaly class density variable quantifying a density of an anomaly class detected within at least the portion of the captured image. The density of the anomaly class can be determined based on one or more of an average size of one or more anomalies (e.g., within the anomaly class) detected within at least the portion of the captured image, an aggregate size of the one or more anomalies, within the anomaly class, detected within at least the portion of the captured image, and/or an aggregate surface area of the one or more anomalies, within the anomaly class, detected within at least the portion of the captured image.

In some implementations, the image processing logic 124 may classify features as belonging to different categories of degradation. For instance, dark artifacts may correspond to silicon carbide particles, while light scatter features may indicate surface film buildup. Classification may be implemented through rule-based logic or using machine learning models trained on labeled image sets. These classifications may be used independently or in combination to support more granular defect scoring and maintenance decision-making. The image processing logic 124 may also support multi-scale analysis, wherein features are extracted at different resolutions or zoom levels to detect both fine-grained defects and broader wear patterns. Temporal analysis may be incorporated to compare features across multiple sequential images and detect changes over time, supporting trend-based assessment of probe head degradation.

In addition to processing 2D image data, the image processing logic 124 may be adapted to operate on 3D surface reconstructions or height maps if the image sensor 122 includes depth-sensing capabilities. In such cases, additional features such as surface roughness, pit depth, or profile deviation may be extracted to supplement the condition evaluation. The output of the image processing logic 124 includes one or more extracted features that quantitatively describe the state of the probe head surface. These features are passed to the measurement integrity logic 144 and/or other downstream entities for further analysis, defect scoring, and/or determination of whether a defect score exceeds a defined threshold warranting user notification or corrective action.

Following the extraction of visual features from the probe head image by the image processing logic 124, the measurement integrity logic 144 analyzes the one or more feature(s) extracted, such as anomalous features identified in anomaly detection, from the captured image in order to generate one or more condition indicator(s) that provide meaningful context regarding specific forms of degradation or contamination. The condition indicators, in turn, may be further processed to generate defect scores including normalized, aggregated metrics that simplify condition evaluation and offer a consistent, objective scale that can be leveraged to enable consistent decision-making across variable image types, degradation patterns, and system configurations. In some implementations, extracted features are directly generated into a defect score without determining a condition indicator as an intermediate operation. In other implementations, a condition indicator is a defect score in itself. A condition indicator may be associated with a particle build-up on the probe head surface, like a silicon carbide spike or carbon build-up. A condition indicator may also be associated with a chemical contamination of a surface of the probe head, like mercury pooling. A condition indicator may also be associated with a physical defect on a surface of the probe head, like a scratch, chip, or deformation.

The raw image features output by the image processing logic 124 (such as a count of dark regions, pixel intensity histograms, or shape descriptors) have limited interpretive value in isolation. The condition indicators serve to translate those features into actionable diagnostics by associating combinations of features with known failure modes or degradation types. For example, if the extracted features include a set of segmented regions exceeding a contrast threshold, along with their respective surface areas, the condition indicator logic may interpret these regions as likely correlating to silicon carbide spike build-up on the probe head surface. In this example, silicon carbide spike build-up is the condition, and the condition indicator(s) that indicate the presence and severity of the condition can include one or more of a total surface area of all dark spots detected on the probe head surface (e.g., representing estimated total contamination), an average size per dark spot (e.g., providing more granular representation of the severity of contamination), and a count of the total dark spots detected. Each condition indicator may be informative in assessing the magnitude of a silicon carbide spike defect. The total surface area of all dark spots, computed as a summation of the area for each detected dark spot, can provide information related to the estimated total magnitude of the particle build-up. The average size of a dark spot can provide a granular, per-spot representation of the severity of the contamination, as a larger spike can be more likely to cause issues than a smaller one. The count of dark spots detected may correlate with the number of individual spike formations or particulate clusters. These three data examples can serve as condition indicators for a specific condition (e.g., silicon carbide accumulation) and reflect how severe the present of that condition may be. Similar sets of condition indicator(s) may be defined for other degradation times, such as mercury residue buildup, mechanical scratching, or liquid pooling.

In various implementations, any number of condition indicator(s) may be determined from the extracted feature(s), and conversely, any number of extracted feature(s) can be factored into a condition indicator. In different implementations, the particular features considered to determine a condition indicator, the condition indicators identified as indicators of interest, and/or the computations employed to determine a condition indicator can be customized to fit specific use cases, and more specifically, varying quality concerns in terms of conformance standards for different conditions and tolerance for nonconformance across different applications. The resultant flexibility in evaluation parameters allows the measurement integrity logic 144 to be applied in a broad range of manufacturing environments by means of context-informed, rule-based processing, statistical interpretation, and/or machine-learned classification.

Once one or more condition indicator(s) have been computed, the system may further generate one or more defect scores based, at least in part, on at least one of the one or more condition indicators. A defect score can provide an aggregate or standardized metric that reflects the severity of a defect condition, or of overall degradation, in a format that can be interpreted for evaluation and comparison more easily than a raw data value. For instance, in one implementation, a silicon carbide buildup defect score may be calculated based on a weighted combination of the three aforementioned condition indicators (total surface area, average size, and count of regions). In another implementation, the defect score may be calculated based further on a calculated change in these values relative to prior image captures. Weighting factors may be empirically derived, user-configurable, or adjusted dynamically over time based on system behavior.

The transformation from condition indicator to defect score offers several advantages. First, it enables aggregation of multiple indicators into a unified metric, such as a generalized probe head degradation score that accounts for multiple failure modes simultaneously. Second, a defect score allows for scaling and standardization of different types of indicators (which may be measured in different units or magnitudes) onto a consistent and intuitive scale. Examples of a scale used for a defect score may include a percentile range from 0-100, a qualitative rule-based classification scale, a quantitative scale based on prior obtained data, or a custom-defined ordinal range. For example, the scaling may be logarithmic, exponential, polynomial, or regression-based, depending on whether the underlying progression of the defect is linear or nonlinear.

Generation of a defect score can be useful to aggregate several condition indicators, but use of a defect score can still be used to improve the interpretability of the data even when a single condition indicator is used. In one example, a raw data value such as “4.2 mm² of region coverage from regions of interest with a measured intensity exceeding two standard deviations greater than the average per-pixel intensity” may not intuitively convey probe status to an operator. Furthermore, it may be difficult to determine urgency from this data, particularly if the relevant defect progresses nonlinearly. However, if the value is standardized to a scale from 0-100, wherein 0 represents no defects and 100 represents “maximum” defects (e.g., total equipment failure with respect to the relevant defect, or equipment that cannot be safely used), a defect score such as a 78 out of 100 is more accessible for interpretation and action by an operator.

Many different types of defect scores may be generated by the monitoring system 100 depending on how the condition indicators are selected, combined, weighted, and processed. In some implementations, individual defect scores may be used to drive alerts or user interface updates, while in others, defect scores may be stored over time for trend analysis, maintenance scheduling, or quality assurance documentation. Whether used in isolation or as part of a broader condition monitoring framework, the generation of defect scores from condition indicators enables a modular, interpretable, and scalable approach to automated probe head integrity assessment.

In some implementations, a scale used to generate a defect score may be constructed by analyzing a corpus of past image data and associated probe head conditions, such as historical inspection results, failure logs, or operator maintenance records. For example, a set of condition indicators (e.g., total dark region surface area, average contrast of segmented regions, or number of artifacts per unit area) may be computed for each image in a dataset that includes both functioning and degraded probe heads. In one implementation, each image may be tagged or correlated with a known condition status, such as “acceptable,” “borderline,” or “failed,” based on maintenance records, downstream wafer test results, or visual inspections by a qualified technician. In other implementations, the images are not labeled and the status is learned via unsupervised learning approaches. Measurement integrity logic 144 can leverage a probe head image dataset to build a defect index, such as a regression curve or machine learning model, that maps combinations of condition indicators to a normalized score reflecting the relative severity of degradation.

In many implementations, a sequence of images of the probe head are used to construct timeseries data that can be leveraged to better anticipate the impacts of defects on probe head integrity over time. Constructing a timeseries using a sequence of captured images may involve processing the sequence of captured images to extract a feature from respective images of the sequence of captured images, analyzing the extracted feature corresponding to the respective images to determine data associated with the condition indicator over time, and generating a respective defect score corresponding to one or more respective images of the sequence of captured images. This timeseries data can be further used to determine a degradation index that quantifies a rate of degradation for the probe head over time. Degradation indexes are discussed in further detail with reference to FIG. 4.

In one example implementation, measurement integrity logic 144 may fit a curve to the historical distribution of condition indicators observed across dozens, hundreds or thousands of probe cycles, using statistical modeling, polynomial regression, or nonparametric methods (e.g., k-nearest neighbors or kernel density estimation) to define a continuous severity function. New condition indicator data captured during operation can then be projected onto the index (wherein projection can refer to comparing the data against the distribution) to generate a defect score that reflects where the current condition falls relative to known degradation trends. This allows the defect score to represent relative severity even if the underlying condition indicators have nonlinear or variable relationships to actual probe head performance. The resulting score may be output on a bounded scale such as 0-100, where 0 corresponds to ideal condition (e.g., within bottom 5th percentile of historical data), 100 corresponds to known failure (e.g., top 95th percentile), and intermediate values reflect proportional degradation.

In some implementations, separate scoring curves may be defined for different condition types (e.g., particulate buildup vs. liquid pooling), or for different probe head models or equipment configurations. Calibration data may be collected during probe set-up, following known cleanings, and/or during scheduled maintenance intervals, and may be used to continuously update or refine the scoring model over time. This approach enables context-aware scoring that reflects actual usage patterns, instrumentation-specific considerations, and evolving quality control criteria, thereby improving accuracy and operator confidence in automated condition assessments.

In another implementation, one or more defect scores may be generated based on the condition indicators computed from extracted image features. A defect score may serve as a standardized, normalized, or aggregated representation of the probe head's degradation state, enabling consistent evaluation and action across different tools, probe head types, or measurement contexts. The measurement integrity logic 144 may employ a range of techniques to transform raw condition indicators into a defect score on a defined scale, such as 0-100, 1-5, or a custom ordinal range. The scale may be linear or nonlinear (e.g., logarithmic, exponential, polynomial, or based on a sigmoid or softmax function), and may be configured to emphasize early degradation, late-stage failure, or other regions of diagnostic interest.

In some implementations, the defect score may be computed using a threshold-based mapping, wherein predefined ranges of condition indicator values are mapped to score bands or levels. For example, if the total surface area of segmented regions falls below a defined threshold, the score may be set to zero; if the area exceeds one or more escalating thresholds, the score may be proportionally increased or capped at a maximum value. In other implementations, the defect score can be calculated as a weighted combination of multiple condition indicators such that each condition indicator is normalized, then weighted by a weight factor to reflect the relative statistical relevance of the associated metric. The weights may be static, user-defined, or learned based on historical data and/or instrument-specific compliance standards.

Once a defect score has been computed based on one or more condition indicators, the measurement integrity logic 144 may evaluate the defect score against one or more threshold values. The threshold(s) can define boundaries at which the monitoring system 100 can prompt additional actions such as generation of a user notification, triggering an automated flag, initiating probe head replacement procedures, and/or adjusting inspection frequency. In some implementations, a single defect score threshold may be defined to represent a minimum acceptable level of integrity. For example, a threshold value of 80 (on a 0-100 scale) may indicate the point at which probe head degradation is deemed sufficiently severe to require intervention. If the current defect score exceeds this threshold, the monitoring system 100 may classify the probe head as compromised or failing and initiate appropriate response actions such as cleaning or replacement of the probe head. The actions initiated by monitoring system 100 can be user-defined in some implementations.

In other implementations, the monitoring system 100 may evaluate a defect score with respect to multiple thresholds, where each respective threshold corresponds to a different severity category and/or type of response prompted by the threshold being satisfied. For example, a warning threshold (e.g., a score exceeding 60 on a 0-100 scale) may indicate early-stage degradation that merits increased monitoring. A maintenance threshold (e.g., a score exceeding 80 on the 0-100 scale) may suggest that the probe head requires maintenance, such as a cleaning procedure. A critical threshold (e.g., a score exceeding 95 on the 0-100 scale) may trigger an immediate halt to further wafer testing or probe usage. These values are arbitrary and provided for illustrative purposes, and should not be interpreted as limiting to the scope of the technology disclosed.

The thresholds defined for a defect score may be static or dynamic. In implementations comprising a static threshold, the threshold can be pre-defined and fixed based on an operator's decision, a manufacturer recommendation, and/or prior data. In implementations comprising a dynamic threshold, thresholds may be adjusted over time in response to operational feedback, such as confirmed probe failures, false positives, and/or changes in downstream wafer quality metrics. Thresholds may also be defined based, at least in part, on the specific use case. In one example, a threshold is defined based partially on the type of condition being monitored (e.g., a lower threshold to trigger replacement of the probe head based on mercury residue than a threshold based on silicon carbide buildup). In another example, a threshold is defined based partially on the probe's expected service life (e.g., lowering the threshold for replacement in an older probe head). In yet another example, a threshold is defined based partially on the specific probe system or configuration. In other examples, a threshold is defined based partially on the sensitivity or tolerance level of the work product being evaluated or downstream applications.

In some implementations, thresholds may be defined not only for a defect score, but also for the underlying condition indicators used to generate the defect score. This allows for fine-grained control over which patterns of degradation trigger alerts, even if the composite defect score remains within acceptable bounds. For instance, a spike in the count of dark regions may trigger a specific warning related to particulate contamination, even if the total defect score has not yet crossed the maintenance threshold. Threshold values may be specified manually, selected from a predefined configuration profile, learned from historical inspection data, and/or derived from one or more of a simulation, calibration routine, and operator feedback loop. In machine learning-based implementations, thresholds may correspond to decision boundaries learned from labeled training data and may adapt over time as the model continues to learn from new examples.

Once a defect score has been generated and evaluated against one or more thresholds, the monitoring system 100 can respond to the evaluation of the defect score in various downstream operations, as determined by how the system is configured (e.g., settings for different rules and parameters, as described further with respect to notification logic 106) and whether one or more threshold(s) have been satisfied. In some implementations, a defect score that satisfies a threshold is interpreted as an indicator of nonconformance for the probe head 114. A defect score may be interpreted as indicating nonconformance (e.g., by the measurement integrity logic 144) with respect to one or more parameters in particular, or alternatively, with respect to probe integrity in general. When a defect score has been evaluated as indicative of nonconformance, the measurement integrity logic 144 may generate a nonconformance record and transmit the nonconformance record to be stored in a data log, e.g., within data storage 110. In other implementations, monitoring system 100 may be configured to generate a quality record more frequently even when noncompliance has not been detected, such as generating a quality record each time a defect score is generated, each time an image is captured, and/or per a rule-based schedule. For example, a quality record may be logged periodically based on a fixed time-interval, or a fixed interval based on a certain quantity of captured images. The quality log may contain data that corresponds to one captured image, or multiple captured images. A nonconformance record may be a separate record, in addition to a general quality record, or the quality record may be flagged as a nonconformance record with additional data included with respect to the nonconformance. The quality records and/or nonconformance records stored within the data log can be leveraged for traceability, auditing, and long-term data analysis. A record in the log can include, for example, any combination of the captured image data, the extracted features, condition indicator values, the defect score, the threshold(s) that were satisfied (if any), a timestamp, probe head metadata (e.g., serial number, cycle count), and any corrective actions taken or recommended.

In addition to data logging, threshold outcomes may also be used to trigger automated notifications or user alerts that enable proactive response before damage propagates downstream. These notifications may include real-time messages pushed to a local user interface, such as a GUI operating on user device 108, or visual/auditory signals on the probe system itself. The generation and presentation of notifications are described in greater detail with reference to FIG. 2B. Additionally, the outcome of the threshold comparison may be used to dynamically inform measurement corrections. For example, if a particular degradation condition is known to introduce a measurable bias or noise component into the electrical readings of the probe system, measurement correction logic 164 may apply a correction factor or weighting adjustment to account for the current level of degradation indicated by the defect score. This corrective logic may be used to improve data reliability even in the presence of early-stage wear or contamination, as described in more detail with reference to FIG. 2C.

The discussion will now turn to the example monitoring workflows depicted in FIGS. 2A, 2B, and 2C.

### Defect Detection and Generation of a Defect Score to Quantify Probe Head Integrity

FIGS. 2A, 2B, and 2C are message flow diagrams that illustrate example implementations of how different components within monitoring system 100 may interact to perform defect monitoring, notification, and correction operations. Each respective message flow represents an example implementation involving monitoring system 100 evaluating and responding to probe head degradation, including logging a quality control event (e.g., a quality record or a nonconformance record), issuing a proactive alert, and/or applying a corrective adjustment to measurement data. While the illustrated implementations provide specific examples of these workflows, it should be understood that variations may exist in which different components are involved and/or messages may be routed through intermediate services. Furthermore, the operations may occur in a different order, repeat, or occur asynchronously. FIGS. 2A-2C are not intended to be limiting, but rather illustrative of the modular and adaptable nature of the system architecture.

### Defect Monitoring Workflow

FIG. 2A illustrates a message flow diagram for a defect monitoring workflow 200A, representing an example implementation including the monitoring system 100 capturing data and evaluating data reflecting the condition of a probe head 114. The operations of workflow 200A include feature extraction, condition assessment, scoring, and threshold evaluation. The sequence depicted reflects one example implementation and may vary across different system configurations, such as with reordered steps, parallel processing, or alternative data routing between modules.

In operation 202, the image capture trigger logic 101 initiates a request to the vision module 102, triggering image sensor 122 to capture a new image of the probe head 114. This request may be triggered by elapsed time, cycle count, external input, or other configurable parameters, as previously described above. In operation 204, vision module 102 responds by capturing the requested image of the probe head, followed by transmitting the image to the image processing logic 124 in operation 206. In many implementations, operation 204 can also be prompted by user input via the user device 108 rather than in response to operation 202. In operation 208, the image processing logic 124 performs feature extraction on the captured image. The one or more extracted feature(s) may include region shape descriptors, contrast levels, pixel intensity distributions, size and count of regions of interest, and other measurable attributes suitable for assessing probe head degradation, such as those described above with reference to the image processing logic 124. The extracted feature(s) can be transmitted to the measurement integrity logic 144 in operation 210.

In operation 212, measurement integrity logic 144 analyzes the extracted image features to determine one or more condition indicators. A condition indicator is a diagnostic metric derived from the raw image feature data, providing context-specific insight into the integrity of the probe head based on a particular condition of interest. For example, image features such as the count, surface area, or contrast of segmented regions may be processed to identify the presence and severity of degradation phenomena, such as silicon carbide spike accumulation or mercury residue buildup. A condition indicator may reflect the total area covered by such regions, the average size per region, the count or density of artifacts, or the rate of change in such metrics over time. Each condition indicator can represent a quantified evaluation of a specific degradation mode and serve as a building block for further diagnostic scoring.

In operation 214, measurement integrity logic 144 generates one or more defect scores based on the condition indicators. A defect score provides a standardized and interpretable representation of degradation severity. In various implementations, the system may compute the defect score by normalizing condition indicator values to a defined scale, such as 0-1, 0-100, or 1-5. The score may be a weighted combination of multiple condition indicators, where each condition is assigned a different level of influence based on empirical importance, operational context, and/or user configuration. In other implementations, the condition indicator values may be projected onto a calibrated degradation index or scoring curve, constructed using historical or calibration data from previously used probe heads. In such cases, the defect score may act as a proxy for remaining useful life (RUL), providing predictive insight into how long the probe head may continue functioning before replacement or maintenance is needed. Multiple types of defect scores may be generated simultaneously. For instance, a first defect score may reflect short-term maintenance urgency (e.g., cleanliness or surface residue), while a second score may represent long-term degradation trends related to probe wear or cumulative damage. These scores may be logged independently or combined in downstream decision logic. In certain implementations, a so-called “sub-score” can be calculated for respective image features (e.g., one sub-score computed for a count of regions of interest, another sub-score computed for an average size of regions of interest, and another sub-score computed for a surface area of the probe that is obscured by a defect) and a final score can then be computed as an aggregation of the sub-scores. In some implementations, the sub-scores may be weighted prior to aggregation into a final score. Some implementations may also include a pre-set upper limit or normalization scheme for a particular sub-score that is also taken into account by the final score.

In operation 216, measurement integrity logic 144 performs evaluation of the defect score against one or more thresholds to determine whether any further action is required. A variety of thresholding strategies may be used. For example, thresholds may be defined as minimum or maximum allowable values, score ranges, or percentage-based tolerances. In some cases, multiple levels of thresholds may be configured to reflect severity gradations. In one example implementation, a defect score can be compared against a “warning” threshold (e.g., mild degradation), a “cleaning” threshold (e.g., moderate contamination), a “maintenance” threshold (e.g., wear approaching critical), and a “replacement” threshold (e.g., end-of-life condition). Alternatively or additionally, thresholds may be defined as qualitative categories such as “normal,” “attention,” or “critical.” These thresholds may be static (e.g., pre-defined by the user or manufacturer), dynamic (e.g., adjusted based on recent trends or batch context), or adaptive (e.g., automatically re-learned from previous data). The result of this threshold evaluation may determine whether a log is escalated, whether a notification should be issued (described further with reference to FIG. 2B), or whether corrective adjustments should be made to measurement data (described further with reference to FIG. 2C).

Various implementations may include different modes of operation for monitoring system 100, and each mode of operation may include one or more respective trigger mechanisms related to the image capture trigger logic 101. In some implementations, monitoring system 100 may operate in a PLC Trigger Mode. For example, PLC Trigger Mode may be used in any mercury probe metrology measurements (e.g., doping) in a production environment. In one implementation involving an automated mercury probe metrology system, a PLC controls wafer movement in order to automatically load wafers into the system. In PLC Trigger Mode, imaging sensor 122 is triggered (e.g., via image capture trigger logic 101) to capture an image of the surface of probe head 114 prior to the wafer being moved in place for measurement by probe head 114. In some implementations involving PLC Trigger Mode, one or more outputs of the imaging process logic 124 and/or the measurement integrity logic 144 can be compared to at least one pre-defined threshold prior to the wafer being moved in place for measurement by probe head 114. Accordingly, when a pre-defined threshold is satisfied indicating that the probe head is defective or nonconforming, the process is paused to prevent measurement of the wafer to prevent inaccurate measurements and/or damage to the wafer.

In other implementations, monitoring system 100 may operate in a Manual Trigger Mode, e.g., some implementations relating to troubleshooting and diagnostics operations. Manual Trigger Mode may include image capture trigger logic 101 triggering imaging sensor 122 to capture an image in response to a received user input for manual trigger. Manual Trigger Mode can be useful, for example, for allowing a user like a service engineer to evaluate and verify the integrity of the image capture operations. Furthermore, Manual Trigger Mode may also enable a user to visually inspect the image of the probe head surface in a service mode or in an R&D environment. In yet other implementations, monitoring system 100 may operate in a Live Mode that shows a “live” feed of continuously captured images, rather than waiting for a specific trigger request per each capture. Live Mode may be leveraged when calibrating the positioning or other parameters of the imaging sensor 122, for example. Many implementations may include the option to use two or more of the PLC Trigger Mode, Manual Trigger Mode, and/or Live Mode such that the operation mode is changed in different contexts or in response to user input. For example, an automated mercury probe metrology system that involves automatically loading wafers into the system may be configured to allow for PLC Trigger Mode, Manual Trigger Mode, or Live Mode. Alternatively, a semi-automated mercury probe metrology system that allows for manual loading of a wafer may only leverage Manual Trigger Mode or Live Mode.

### Notification Workflow

FIG. 2B illustrates a message flow diagram for a notification workflow 200B, representing an example implementation including the monitoring system 100 generating a notification reflecting the condition of a probe head 114. The sequence depicted reflects one example implementation and may vary across different system configurations, such as with reordered steps, parallel processing, or alternative data routing between modules.

Workflow 200B begins with operation 216, continuing from workflow 200A. As described previously, in operation 216, the measurement integrity logic 144 evaluates one or more computed defect scores against predefined thresholds to assess whether the current state of the probe head is indicative of a nonconformance or degradation condition. However, in other implementations, workflow 200B does not need to continue from workflow 200A. In some implementations, the notification flow may be initiated independently from the defect score evaluation in operation 216. For example, a notification may be generated in response to a user request for a status update or summary report via a graphical user interface (GUI) displayed on display 128 of user device 108.

In operation 222, measurement integrity logic 144 logs a nonconformance record in data storage 110 in response to the defect score satisfying a threshold indicating a nonconformance (e.g., a threshold associated with cleaning, maintenance, and/or replacement of the probe head 114). In other implementations, operation 222 may involve measurement integrity logic 144 logging a quality record in data storage 110 regardless of whether the defect score satisfied a threshold, or if a satisfied threshold indicates noncompliance. A record in the data log may include one or more of the captured image(s), extracted image feature(s), determined condition indicator(s), defect score(s), and/or additional metadata, such as a timestamp, a probe head identifier, tool configuration data, or recent usage history. These records facilitate traceability and support downstream auditing or quality control investigations.

In operation 224, the notification logic 106 sends a message to user device 108, prompting display of a notification. In operation 226, the notification is presented via a display 128 on the user device 108. In many implementations, the notification is displayed within a GUI environment. The nature of the notification can vary based on the evaluated severity level. For example, the notification may include a warning that cleaning, maintenance, inspection and/or replacement is recommended soon (or immediately), alert that user intervention is required, provide an estimate for the remaining useful life (RUL) of the probe head 114, indicate that the probe head may not be fit for use and recommend pausing probe measurements, and/or identify one or more wafer(s)/wafer batches potentially impacted by a detected defeat of the probe head 114.

The GUI may display additional associated data alongside the notification message, including one or more captured image(s), defect score(s), condition indicator(s), threshold status for one or more thresholds, and/or a timestamp. In some implementations, the GUI may present a basic overview including a limited selection of data initially, with interactive elements enabling the user to request more detailed information such as trend graphs, historical comparisons, or expanded metrics. The structure, formatting, and content of the notification may be user customizable. Examples of user-customizable options may include configuring which data types appear initially by default, defining the content of a message to be displayed for a particular notification and severity level, defining one or more criteria for when a notification should be displayed, and requiring a user acknowledgment of a notification in order to dismiss or archive the notification.

In operation 228, the user may provide input via the GUI, such as acknowledging a notification, requesting more data, and/or scheduling a follow-up inspection. This input may be received via user input device 148. In one example, the user input is a request for additional information. In another example, the user input causes an additional analysis to be performed, which can be further logged in data storage 110. In yet another example, the user input may be an instruction to temporarily dismiss the notification and re-display the notification as a reminder at a later time, such as a pre-defined time interval like 10 minutes, 1 day, or 30 days. Information regarding user interactions, such as who cleared a notification, when it was acknowledged, or whether additional information was accessed, may be stored for audit and traceability purposes.

In alternative implementations, user input received in operation 228 may prompt the GUI to retrieve and display a general condition report for the probe head. The user input may or may not be prompted by a notification. This report may include a single data point (e.g., from the most recent inspection), a series of historical records (e.g., the last 3, 5, or 10 inspections), or a summary (e.g., average or trend of condition indicators over the past day or week). The displayed data may include one or more captured images, extracted features, condition indicators, and/or defect scores, with customizable formatting and selection based on user preference. These reports may be displayed whether or not a threshold has been met, allowing operators to proactively monitor degradation patterns and plan maintenance on a predictive basis.

Notification workflow 200B illustrates just one example of how alerts and feedback may be presented in connection with the monitoring operations of monitoring system 100. In alternative implementations, other forms of messaging, delivery channels, escalation policies, or automated responses may be implemented to accommodate different operational environments or user preferences.

### Measurement Correction Workflow

FIG. 2C illustrates a message flow diagram for a measurement correction workflow 200C, representing an example implementation including the monitoring system 100 generating corrected measurement data with respect to a probe head 114. The sequence depicted reflects one example implementation and may vary across different system configurations, such as with reordered steps, parallel processing, or alternative data routing between modules.

Workflow 200C begins with operation 216, corresponding to operation 216 in workflows 200A and 200B, in which measurement integrity logic 144 evaluates one or more defect scores generated from probe head image analysis against thresholds as previously described. The resulting evaluation may indicate a nonconformance condition or trigger further downstream actions. Workflow 200C may proceed directly from workflow 200A or 200B as a continuation, or it may be initiated separately, such as in response to a user request from the GUI on user device 108. In some implementations, notification workflow 200B and measurement correction workflow 200C may operate in parallel or certain operations may be performed at least partially concurrently with one another. In one example, a notification may be displayed to the user in operation 226 indicating that a particular defect has been detected exceeding a predefined threshold. The user input operation in operation 228 may include the user requesting that a measurement correction be performed based on the defect data. In another example, the measurement correction operations may begin after measurement integrity logic 144 completes evaluation in operation 216 and the operations of workflow 200C can overlap at least partially with the operations of workflow 200B (e.g., simultaneously, in parallel, or concurrently).

Following operation 216, operation 222 involves measurement integrity logic 144 logging a nonconformance record in data storage 110, as described above. In operation 242, the measurement integrity logic 144 also transmits the defect score to measurement correction logic 164. Operations 222 and 242 may be performed in any order, including simultaneously. The specific reference to the defect score in operation 242 should not be interpreted as limiting, as many other types of data can be transmitted from measurement integrity logic 144 in operation 242 that have been omitted from FIG. 2B for clarity. In many implementations, the data transfer within operation 242 may include additional data about the probe head condition, such as extracted feature(s) condition indicator(s), timestamp(s), and/or captured image data. Additional defect data may also be obtained from data storage 110. In operation 244, the measurement correction logic 164 retrieves the probe measurement data from data storage 110. This measurement data represents the values acquired by the probe head in connection with testing a sample (e.g., a wafer), such as capacitance-voltage (C-V) curves, doping profiles, or oxide thickness measurements.

In operation 246, the measurement correction logic 164 determines a corrective adjustment to apply to the measurement data. The corrective adjustment is leveraged is to compensate for systematic measurement error introduced by the degraded condition of the probe head. Implementations of the technology disclosed compute the corrective adjustment and execute the data correction using several various approaches, and some example implementations are presented below for nonlimiting, illustrative purposes. Other implementations can use similar techniques, or a combination of two or more of the described techniques below.

In some implementations, the measurement correction logic 164 may employ one or more algorithms that map the detected condition indicator(s) and/or defect score(s) to corresponding adjustments based on a combination of empirical data, calibration models, or rule-based heuristics. In one implementation, a calibration dataset is generated by identifying probe heads in various states of progressive deterioration and capturing corresponding measurement outputs and image-derived defect metrics. This calibration data can be used to construct a correction model, such as a regression surface or a multidimensional lookup table, that relates one or more condition indicators (e.g., total surface area of artifacts, average intensity contrast, count of regions of interest) to expected deviations in measurement values. In another implementation, a machine learning model may be trained on historical inspection and measurement data to predict the measurement deviation as a function of the extracted visual indicators, which may then be inverted to generate a corrective adjustment. In other implementations, the correction may also be based on physics-informed constraints, such as known relationships between probe geometry degradation and dielectric breakdown measurements, to bound or regularize the correction process. In yet other implementations, pre-defined rule-based thresholds may be used, such as applying a specific adjustment (e.g., a particular value or percentage to be applied as an addition, subtraction, or scalar multiplication factor). In one example, a rule-based threshold for correction could require that a −5% correction be applied to a measurement in response to silicon carbide spikes exceeding a particular surface area coverage of the probe head. The corrective adjustment may be additive, multiplicative, nonlinear, or involve more complex transformations such as interpolated warping of a measurement curve.

In operation 248, measurement correction logic 164 applies the corrective adjustment and generates corrected measurement data. This corrected data may be stored (e.g., in data storage 110) as a new version of the data alongside the original raw measurement. A determination of which measurement data should be corrected using the corrective adjustment may be performed based on timestamp alignment, wafer tracking metadata, or both. For example, if a timestamp for the captured image associated with the corrective adjustment and the timestamp for a measurement obtained by the probe fall within a pre-defined time window (e.g., 30 seconds, 1 minute, 5 minutes, 10 minutes, or 1 hour), measurement correction logic 164 may identify the measurement as data for correction based on an assumption that the measurement was acquired with the same degraded probe state as captured in the image. In some implementations, such as an implementation in which the image capture is triggered by the loading or unloading of a particular wafer, the wafer ID of said particular wafer can be used to match the measurement data for the wafer with the captured image associated with the wafer.

In one example implementation, an offset correction is used, including applying a calibrated offset to all or part of the measurement curve, based on condition indicators associated with known sources of systematic shift that can be represented by a known mathematical relationship (e.g., mercury pooling or contact resistance). In other examples, the data correction involves a scaling operation, a normalization operation, a curve fitting and/or substitution operation (e.g., using a lookup table or regression model built from prior data to determine a corrected curve based on image-derived indicators of probe condition), multi-variable regression, and/or domain-specific rule-based correction (e.g., parameters related to a type of wafer or class of measurement). In some implementations, the correction logic is dynamic such that the correction model adapts over time as more inspection and measurement data becomes available. In other implementations, the correction logic is rule-based and configured using operator-defined thresholds or empirical mappings. In some implementations, one or more of the aforementioned correction techniques are combined in operation 248.

In some implementations, user input may be required to initiate, authorize and/or finalize correction. For instance, the GUI on user device 108 may prompt the operator to approve or reject a proposed correction, or to select which wafers or data records should be updated. The GUI may also display original versus corrected data for review, or offer interactive tools to tune the correction parameters. A log of all user interactions and correction metadata may be maintained for traceability, e.g., within data storage 110. In operation 250, the corrected measurement data is transmitted to data storage 110, where it may be tagged, timestamped, and optionally version-controlled for future use in downstream workflows, quality reporting, or audit processes.

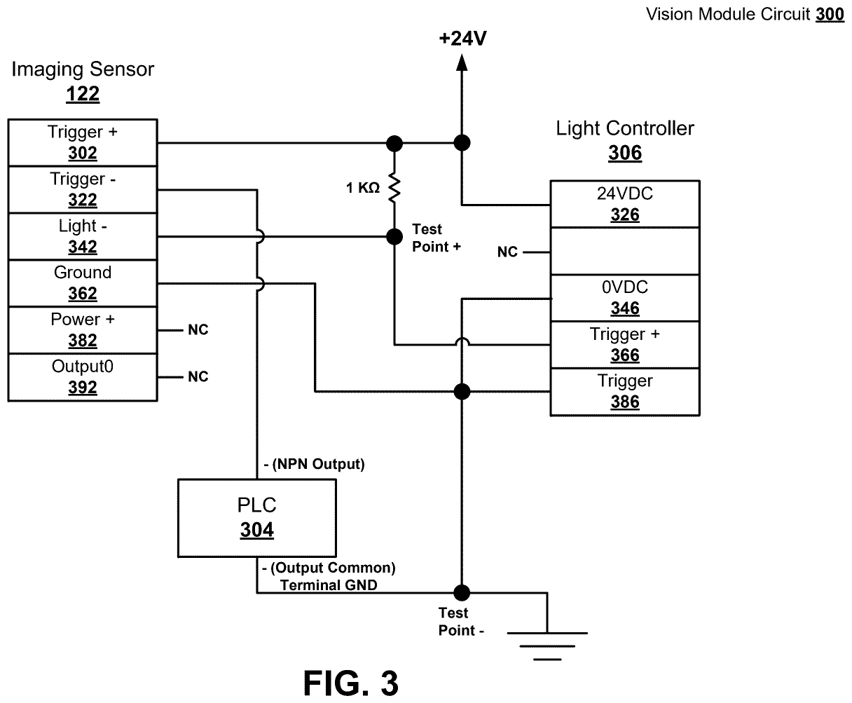

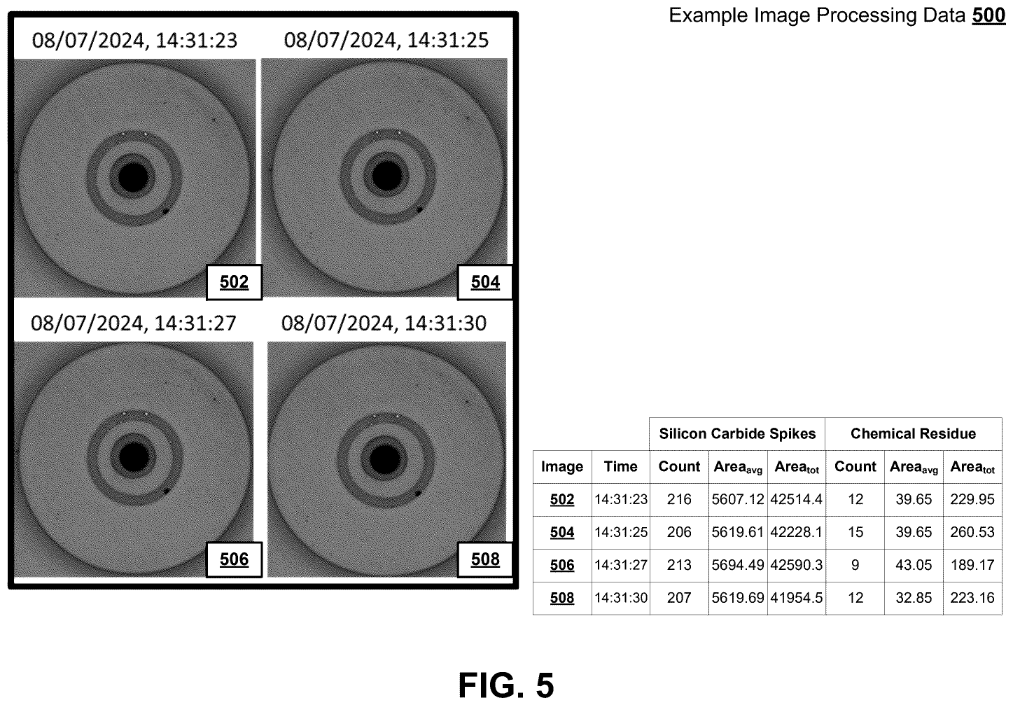

The discussion now turns to the vision module 102 in more detail. An example vision module circuit 102 is introduced with respect to FIG. 3. Next, FIG. 4 depicts example illustrations representing how an image captured by vision module 102 may appear, as well as example data corresponding to the illustrations to provide further understanding as to how the visual features of a probe head may be used to inform defect inspection and quality control. Following the description of FIG. 4, selected real world data will be discussed with reference to FIG. 5 as demonstrative objective indicia of non-obviousness.

### Vision-Based Inspection of a Probe Head for Integrity Monitoring

In some implementations, the vision module 102 includes a camera, lens, lighting apparatus, and lighting controller connected via mechanical fixtures. The vision module 102 can be controlled by various configurations of trigger logic 101 linked to a controller, server, and/or GUI. Operations such as image capture and wafer movement may be coordinated using a same PLC or different PLC boards. In some implementations, imaging sensor 122 is a 12-megapixel monochrome industrial camera, e.g., featuring a Gigabit Ethernet interface, a 256 MB on-board frame buffer, and/or supporting various pixel formats such as Mono8, Mono10, and/or Mono12. Vision module 102 can include one or more additional elements associated with imaging sensor 122, such as at least one of a lens, a lighting apparatus, a control unit, and so on. A lens may be coupled with the imaging sensor 122 to modify a perspective parameter of the imaging sensor 122, such as a zoom level, distortion, focus, and so on. The lens can be a high-resolution, object-space telecentric lens designed for machine vision applications, e.g., featuring various magnification levels (0.5×, 1×, 3×, 5×, 10×, and so on), a working distance, or depth of focus, such as 65 mm (between probe head and the surface of lens), and/or a 1.1 inch image circle. In one example implementation, the lens can be a telecentric lens configured to minimize perspective distortion to enable accurate 3D measurement. The lens may be, for example, a high-resolution object-space telecentric lens. In many implementations, the magnification level, working distance, and/or image circle of a lens can be based, at least in part, on at least one of the configurations of the probe system and the target object to be imaged (e.g., probe head). A lighting apparatus may be used in connection with the camera, such as a ring light to improve uniform illumination. Some implementations can include a power supply, control unit, and/or light controller, such as a light controller configured as a power supply and/or control unit for a lighting apparatus used in connection with image capture and/or computer vision tasks. In one example implementation, the light controller is a compact, 24V-driven LED controller. A light controller may include features such as high-dimming linearity, PWM control, and/or strobe timing parameters. Furthermore, one or more PLCs may be implemented to execute operations associated with the vision module 102 and/or computer vision engine 104. At least one PLC may include features such as Ethernet connectivity, one or more digital inputs, one or more digital outputs, one or more analog input/output channels, and/or support for communication protocols such as TCP/IP.

Some implementations may include one or more interface logics that couple the vision module 102 with the computer vision engine 104, such as logic for enabling real-time (or near real-time) image capture, data processing, data calibration, error detection, and/or pattern recognition. One or more said interface logic(s) can be leveraged to impose quality restraints onto the input data provided to the computer vision engine 104 for processing, e.g., as measured by at least one proxy metric for accuracy, speed, computational efficiency, precision, scalability, or auditability.

FIG. 3 is an example schematic of a vision module circuit 300, in accordance with one implementation of the technology disclosed. Example circuit 300 is a simple wiring diagram includes imaging sensor 122, a light controller 306, and a programmable logic controller (PLC) 304. The representative connections and/or components depicted at imaging sensor 122 are labelled as “trigger+” (302), “trigger−” (322), “light−” (342), “ground” (362), “power+” (382, which may not have a connection, but can also be connected to another component), and “output0” (392, which may not have a connection, but can also be connected to another component). The representative connections and/or components depicted at light controller 306 are labelled as “24V DC” (326), “0V DC” (346), “trigger+” (366), “trigger” (386), and one representative reserved pin, which may not have a connection, but can also be connected to another component. Here the signs of + and − are used to denote polarities. Positive means higher voltage end (often +24V). Negative means lower voltage end (often ground or 0V). In an implementation of the technology disclosed the imaging sensor 122 can be triggered by receiving, at “trigger−” 322, a signal (e.g., an NPN output) from the PLC 304. Then, the light controller 306, which can provide lighting, can be triggered by the “light−” 342 of the imaging sensor 122. This triggering (signal) by the imaging sensor 122 can be received at “trigger+” 366 of the light controller 306 and it can be simultaneous or near simultaneous with the image sensor 122 being triggered by the PLC 304. Test points can be used for troubleshooting when the imaging sensor 122 does not take/sense images. For example, a multi-meter can be used to manually check the voltage between Test Point + and Test Point −, wherein the voltage should be close to 24V. Other circuit configurations may vary, including alternative wiring between various pins, alternative junctions, alternative grounds, or alternative types and placements of resistors, transistors, and/or capacitors. Other configurations can be implemented, as this is only an example, wherein a positive voltage can be implemented as a negative voltage or ground and a negative/ground voltage can be implemented as a positive voltage.

FIG. 4 depicts an illustrative example of progressive degradation of a probe head 114 across multiple timepoints, and how such degradation may be assessed using various image-derived defect scoring strategies. The illustrations shown in FIG. 4 are simplified and stylized for clarity, and the illustrated anomalies are exaggerated representations to facilitate explanation. The provided timepoints, values, thresholds, and scores are purely exemplary and do not limit the scope of possible implementations. The probe head degradation may result from mechanical wear, material buildup, chemical contamination, or other operational stressors, and may impact the performance, safety, or reliability of the probe head over time.

Probe head 114 is illustrated in FIG. 4 at four chronological timepoints: illustration 402 illustrates probe head 114 at time point 0 (“t=0”), illustration 404 illustrates probe head 114 at time point 1 (“t=1”), illustration 406 illustrates probe head 114 at time point 2 (“t=2”), and illustration 408 illustrates probe head 114 at time point 3 (“t=3”). These timepoints may correspond to sequential captures over time, such as after a certain number of probe head operations, elapsed time intervals, or after cleaning cycles. The elapsed time between any two adjacent timepoints need not be equal in length to the elapsed time between any other two adjacent timepoints. The images may or may not be consecutive captures, and intervening images may have been captured but are not shown. In some implementations, image capture is triggered periodically or conditionally, such as after a predefined number of measurements or wafers.

Illustration 402 represents an example of a “pristine” or baseline probe head 114, meaning that the probe head has no visible anomalies or features of interest detected at time point 0. Subsequent illustrations depict progressively worsening conditions, including the emergence and morphological evolution of features of interest. In this example, two types of anomalies are referenced. Dark-colored anomalies, represented as black “blobs” on the illustrated probe head, are indicative of silicon carbide spike build-up or carbon residue. Light-colored anomalies, represented as white “blobs” on the illustrated probe head, are indicative of mercury pooling or other chemical contaminant residue. These anomalies are detected based on one or more anomalous features, such as regions exceeding certain contrast, brightness, or shape thresholds, and are then used to derive condition indicators and defect scores.

FIG. 4 includes four different example defect scores, including defect score 420, defect score 440, defect score 460, and defect score 480 (note that these numbers 420, 440, 460 and 480 do not represent defects scores themselves, but they are rather reference numbers to identify different defects scores that are based on different condition indicators). Each example defect score in FIG. 4 reflects a different example implementation for quantifying the condition of the probe head based on one or more condition indicators. All of the example defect scores in FIG. 4 are normalized to a standardized scale, such as 0 to 100, where 0 corresponds to a “no defect” state and 100 corresponds to a maximum-severity condition, though the maximum may vary based on the application, tolerance, or calibration baseline. However, it is to be understood that this scale is chosen to improve the clarity and accessibility of the description and other defect score schema exist in other implementations, as described previously.

Defect score 420 is based on condition indicators derived from dark-colored, high-contrast anomalies. These anomalies may be associated with physical contamination such as silicon carbide spike accumulation or carbon residue. Anomalous features such as blob area, intensity, count, and spatial distribution may be extracted from the image, and further processed into one or more condition indicators. For example, three condition indicators may be determined from the extracted features including total surface area of the dark blob anomalies, a count of the dark blob anomalies, and an average contrast or intensity of the dark blob anomalies. These indicators can be used to compute a defect score scaled from 0-100. The scale may be linear or nonlinear and can be defined based on calibration data, domain-specific degradation tolerance, or historical failure patterns. The three example thresholds provided for defect score 420 are a warning threshold set at 40, a maintenance threshold set at 60, and a replacement threshold set at 80. As depicted in FIG. 4, no anomalies are detected at timepoint 0 (illustration 402) and hence, the defect score 420 at time point 0 is equal to 0. Because the defect score does not satisfy any thresholds, no notification is prompted. At timepoint 1 (illustration 404), one dark blob anomaly is detected. Although white blobs are also detected, these features are not taken into account for defect score 420 because defect score 420 is defined relative to condition indicators for silicon carbide build-up. The defect score 420 determined at timepoint 1 (illustration 404) is a value of 15, and again, no threshold is satisfied so no notification is prompted. At timepoint 2 (illustration 406), three dark blob anomalies are now visible. The defect score 420 has jumped to 53 at timepoint 2 (illustration 406), e.g., based on the three aforementioned condition indicators related to the size and coverage of dark blob anomalies on probe head 114. A defect score 420 equal to 53 exceeds the warning threshold value of 40, so a warning notification is prompted stating “Warning! Maintenance required soon.” At timepoint 3 (illustration 408), six dark blob anomalies are now visible and the defect score 420 is equal to 75. The defect score 420 at timepoint 3 (illustration 408) exceeds the maintenance threshold, prompting a notification stating “Alert: Maintenance required.”

As previously described, the notification may include additional data in addition to, or in place of, a warning or alert message. In some implementations, a notification may also be prompted when a defect score is nearing a threshold (e.g., a pre-defined tolerance or range surrounding the exact threshold). In one example with respect to defect score 420 and illustration 408, the defect score value of 75 may also prompt a warning that the defect score is close to the replacement threshold, even though the defect score has not yet reached the threshold, to aid in planning for future maintenance.

Defect score 440 is similar to defect score 420, but defect score 440 is generated based on condition indicators derived from the light-colored blob anomalies, indicative of mercury pooling or residual films on probe head 114. Threshold values for defect score 440 are lower than that of defect score 420, and this may be due to a user instruction that prioritizes maintenance action in response to mercury pooling over other defects. For defect score 440, a warning threshold is defined at a score of 20, a maintenance threshold is defined at a score of 40, and a replacement threshold is defined at a score of 60. Accordingly, a warning is prompted at timepoint 1 (illustration 404) in response to the condition indicators related to the three light blob anomalies depicted at timepoint 1. A maintenance alert is prompted at timepoint 2 (illustration 406) in response to the condition indicators related to the five light blob anomalies. At timepoint 3 (illustration 408), a replacement alert is prompted in response to the eight light blob anomalies.

In contrast to defect score 420 and defect score 440, which are each defined respective to specific classes of anomalies, defect score 460 combines data related to multiple classes of anomalies to quantify an overall degree of probe head degradation. This defect score reflects a general-purpose degradation index and supports comprehensive condition monitoring, even when anomalies stem from multiple co-occurring causes. Accordingly, defect score 460 is generated based on anomalous features and condition indicators related to both the dark blob and light blob anomalies. As such, the probe head 114 receives a replacement alert sooner with respect to defect score 460 (e.g., at time point 2) than with respect to either defect score 420 or defect score 440, because certain factors were not taken into account by either defect score 420 or defect score 440. Hence, the example of defect score 460 illustrates that broader degradation metrics may prompt corrective action earlier than single-defect scores in certain cases, due to aggregation of multiple condition indicators.

Defect score 480 is similar to defect score 460, but defect score 480 incorporates an additional time factor as another condition indicator, such as the time elapsed since the probe head 114 was manufactured or installed, the amount of time probe head 114 has been actively in use, and/or the quantity of operational cycles performed by probe head 114. Hence, defect score 480 is based on a time-dependent degradation index and can serve as a proxy for lifespan monitoring.

A degradation index can be constructed by analyzing a corpus of captured data that includes visual features, condition indicators, and associated probe head outcomes across various points in time. In some implementations, this involves capturing images of probe heads at regular intervals during their operational lifecycle, extracting relevant anomalous features (e.g., size, shape, count, and/or texture of anomalies), and annotating these features with metadata such as timestamps, maintenance history, and/or known probe failures or replacements. Statistical or machine learning models can then be applied to identify patterns or trajectories in the extracted condition indicators that are predictive of degradation. These models may include regression curves, probabilistic survival models (e.g., Weibull or log-logistic distributions), or unsupervised dimensionality reduction techniques that map current condition indicators onto a multi-dimensional degradation curve. Once constructed, the degradation index enables projection of determined condition indicators onto the same model space. The degradation index thereby provides a standardized score or ranking that reflects the current degradation status of a probe head relative to its expected lifecycle, sometimes referred to as the “remaining useful life” (RUL). This score may be used to estimate remaining useful life, trigger preemptive maintenance, or calibrate warning and replacement thresholds based on observed degradation trends. In some implementations, the degradation index may be updated over time as more data is collected, allowing the index to improve in accuracy and adapt to changing usage patterns or probe head designs.

Accordingly, the defect score 480 is a proxy for the estimated percentage lifespan that has already been used by probe head 114, and the amount of useful life remaining for probe head 114. Accordingly, since probe head 114 is a new probe head at timepoint 0 (illustration 402), the notification indicates that the RUL is 100% at timepoint 0. By timepoint 1 (illustration 404), the estimated RUL has dropped to 62%. Based on the pre-defined warning threshold of 25, the notification can further state “Warning!” in addition to providing the RUL estimation. By timepoint 2, the estimated RUL has dropped to 35% and an alert is prompted based on the pre-defined alert threshold of 50. By timepoint 3, the estimated RUL has dropped to 15%, and an alert indicating that replacement will be necessary soon is also prompted based on the pre-defined alert threshold of 75.

The example thresholds and scoring models of FIG. 4 may be predefined, dynamically learned, application-specific, user-configurable, and/or adaptive based on user feedback, model refinement, or automated recalibration based on machine learning models. Scales may be linear, logarithmic, exponential, polynomial, or a hybrid thereof. In some implementations, different defect scores are shown concurrently in a graphical user interface (GUI) and may be color-coded, overlaid, or plotted against time. It should be understood that the illustrated strategies of FIG. 4 represent example implementations. In alternative implementations, different numbers of timepoints, defect scores, or anomaly types may be used. Some systems may track additional environmental or usage variables (e.g., humidity, current draw, measurement drift) to supplement defect scoring. Furthermore, while four distinct scores are described in FIG. 4, a single unified scoring system or alternate set of scores could be implemented instead, depending on the monitoring strategy, processing constraints, and/or domain requirements.

### Objective Indicia of Non-Obviousness

FIG. 5 provides an example of real-world data that serves as objective indicia of non-obviousness supporting the technology disclosed herein. Unlike the simplified and exaggerated illustrations shown in FIG. 4 for explanatory clarity, the data in FIG. 5 highlights the practical challenges and advantages associated with implementing an automated image analysis system for probe head degradation. In particular, FIG. 5 demonstrates how small and subtle the relevant defects often can appear on a probe head. The defects may be barely visible, or not visible at all, to the human eye under typical inspection conditions, thereby illustrating why conventional manual visual inspection lacks the sensitivity, consistency, and objectivity necessary for reliable monitoring.

FIG. 5 includes multiple captured images of a probe head acquired at different timestamps during operation, including image 502 (timestamp 14:31:23), image 504 (timestamp 14:31:25), image 506 (timestamp 14:31:27), and image 508 (timestamp 14:31:30). For each image, associated data is shown reflecting extracted features for at least two distinct classes of anomalies. These classes correspond, for example, to (i) silicon carbide spike buildup and (ii) chemical residue accumulation, two common and operationally significant defect modes in probe head degradation. For each anomaly class, data is shown for the number of anomalies detected, the average surface area per anomaly, and the total cumulative surface area of all anomalies in the class. These extracted features may be used individually or in combination to generate condition indicators. The condition indicators may then be further processed into defect scores in which each defect score corresponds to one class (e.g., a silicon carbide spike score or a chemical residue score), or to a combination of multiple classes (e.g., a generalized degradation score). The features and condition indicators may be weighted, normalized, aggregated, or processed through scaling functions depending on the intended use, thereby enabling flexible, data-driven insights into the state of the probe head.

### Computer System

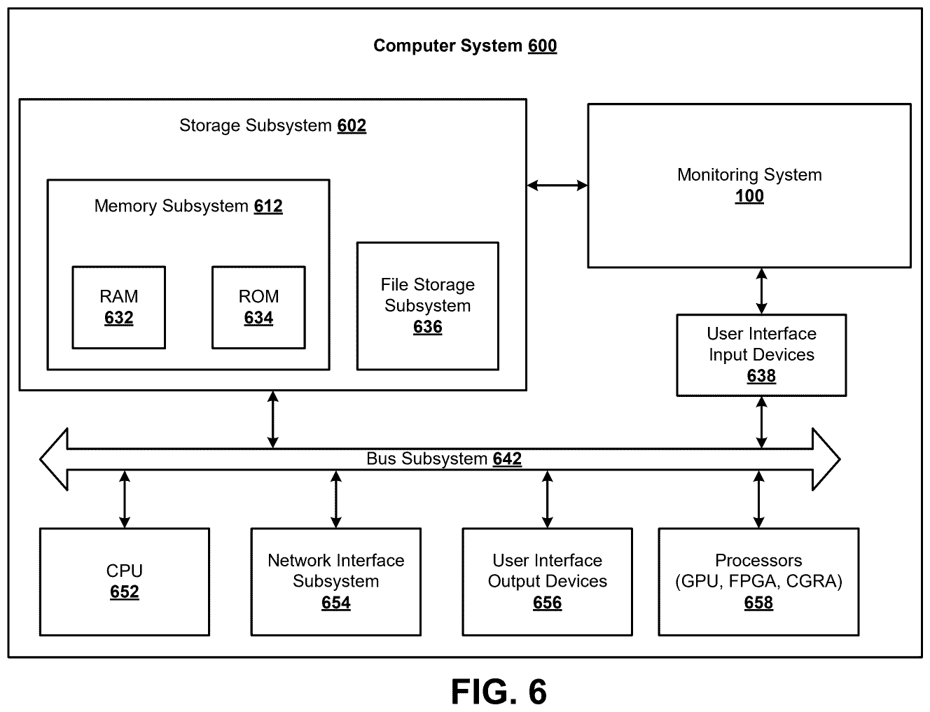

FIG. 6 illustrates a block diagram of a computer system 600 that can be used to implement the technology disclosed. Computer system 600 includes at least one central processing unit (CPU) 652 that communicates with a number of peripheral devices via bus subsystem 642. These peripheral devices can include a storage subsystem 602 including, for example, memory devices and a file storage subsystem 636, user interface input devices 638, user interface output devices 656, and a network interface subsystem 654. The input and output devices allow user interaction with computer system 600. Network interface subsystem 654 provides an interface to outside networks, including an interface to corresponding interface devices in other computer systems.

In one implementation, the monitoring system 100 is communicably linked to the storage subsystem 602 and the user interface input devices 638.

In another implementation, the control unit 626 of the depot and the control unit 632 of the transporter are also communicably linked to the storage subsystem 602 and the user interface input devices 638.

User interface input devices 638 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 600.

User interface output devices 656 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 600 to the user or to another machine or computer system.

Storage subsystem 602 stores programming and data constructs that provide the functionality of some or all of the modules and methods described herein. These software modules are generally executed by processors 658.

Processors 658 can be graphics processing units (GPUs), field-programmable gate arrays (FPGAs), application-specific integrated circuits (ASICs), and/or coarse-grained reconfigurable architectures (CGRAs). Processors 658 can be hosted by a deep learning cloud platform such as Google Cloud Platform™, Xilinx™, and Cirrascale™. Examples of processors 678 include Google's Tensor Processing Unit (TPU)™, rackmount solutions like GX4 Rackmount Series™, GX16 Rackmount Series™, NVIDIA DGX-1™, Microsoft' Stratix V FPGA™, Graphcore's Intelligent Processor Unit (IPU)™, Qualcomm's Zeroth Platform™ with Snapdragon Processors™, NVIDIA's Volta™, NVIDIA's DRIVE PX™, NVIDIA's JETSON TX1/TX2 MODULE™, Intel's Nirvana™, Movidius VPU™, Fujitsu DPI™, ARM's DynamicIQ™, IBM TrueNorth™, Lambda GPU Server with Testa V100s™, and others.

Memory subsystem 612 used in the storage subsystem 602 can include a number of memories including a main random access memory (RAM) 632 for storage of instructions and data during program execution and a read only memory (ROM) 634 in which fixed instructions are stored. A file storage subsystem 636 can provide persistent storage for program and data files, and can include a hard disk drive, a floppy disk drive along with associated removable media, a CD-ROM drive, an optical drive, or removable media cartridges. The modules implementing the functionality of some implementations can be stored by file storage subsystem 636 in the storage subsystem 602, or in other machines accessible by the processor.

Bus subsystem 642 provides a mechanism for letting the various components and subsystems of computer system 600 communicate with each other as intended. Although bus subsystem 642 is shown schematically as a single bus, alternative implementations of the bus subsystem can use multiple busses.

Computer system 600 itself can be of varying types including a personal computer, a portable computer, a workstation, a computer terminal, a network computer, a television, a mainframe, a server farm, a widely-distributed set of loosely networked computers, or any other data processing system or user device. Due to the ever-changing nature of computers and networks, the description of computer system 600 depicted in FIG. 6 is intended only as a specific example for purposes of illustrating the preferred implementations of the present invention. Many other configurations of computer system 600 are possible having more or less components than the computer system depicted in FIG. 6.

Each of the processors or modules discussed herein may include an algorithm (e.g., instructions stored on a tangible and/or non-transitory computer readable storage medium) or sub-algorithms to perform particular processes. The monitoring system 100 is illustrated conceptually as a collection of modules, but may be implemented utilizing any combination of dedicated hardware boards, DSPs, processors, etc. Alternatively, the monitoring system 100 may be implemented utilizing an off-the-shelf PC with a single processor or multiple processors, with the functional operations distributed between the processors. As a further option, the modules described below may be implemented utilizing a hybrid configuration in which some modular functions are performed utilizing dedicated hardware, while the remaining modular functions are performed utilizing an off-the-shelf PC and the like. The modules also may be implemented as software modules within a processing unit.

Various processes and steps of the methods set forth can be carried out using a computer. The computer can include a processor that is part of a detection device, networked with a detection device used to obtain the data that is processed by the computer or separate from the detection device. In some implementations, information (e.g., image data) may be transmitted between components of a system disclosed herein directly or via a computer network. A local area network (LAN) or wide area network (WAN) may be a corporate computing network, including access to the Internet, to which computers and computing devices comprising the system are connected. In one implementation, the LAN conforms to the transmission control protocol/internet protocol (TCP/IP) industry standard. In some instances, the information (e.g., image data) is input to a system disclosed herein via an input device (e.g., disk drive, compact disk player, USB port etc.). In some instances, the information is received by loading the information, e.g., from a storage device such as a disk or flash drive.

A processor that is used to run an algorithm or other process set forth herein may comprise a microprocessor. The microprocessor may be any conventional general purpose single- or multi-chip microprocessor such as a Pentium™ processor made by Intel Corporation. A particularly useful computer can utilize an Intel Ivybridge dual-16 core processor, LSI raid controller, having 168 GB of RAM, and 2 TB solid state disk drive. In addition, the processor may comprise any conventional special purpose processor such as a digital signal processor or a graphics processor. The processor typically has conventional address lines, conventional data lines, and one or more conventional control lines.

### Particular Implementations

The technology disclosed relates to a system and methods for automatic and passive monitoring of a probe-based measurement system. The disclosed method can include using an imaging device to capture an image of a probe head, processing the captured image using an image processing model to extract a feature of the captured image of the probe head, analyzing the extracted feature to determine a condition indicator for the probe head, generating a defect score based, at least in part, on the determined condition indicator, evaluating the generated defect score based on a pre-defined threshold stored in a memory, wherein a particular defect score satisfying the pre-defined threshold indicates a nonconformance in association with the determined condition indicator, and in response to the generated defect score satisfying the pre-defined threshold, logging a nonconformance record for the probe head in a data log, wherein the nonconformance record includes a timestamp and data identifying at least one of the extracted feature, the determined condition indicator, and the generated defect score.

In one method implementation, the extracted feature is an anomaly detection feature of the captured image, based on one or more attributes, wherein an attribute of the one or more attributes is an anomalous feature detection variable identifying one or more anomalous features detected within at least a portion of the captured image, wherein the particular anomalous feature is associated with at least one of: a signal intensity, a contrast, a brightness, a boundary attribute, and a region attribute. In another method implementation, an attribute of the one or more attributes is an anomaly classification variable identifying one or more anomaly classes detected within at least the portion of the captured image, wherein the one or more anomaly classes identified by the anomaly classification variable are determined based, at least in part, on the anomalous feature detection variable.

In another method implementation, an attribute of the one or more attributes is an anomaly frequency variable quantifying a count of one or more anomalies detected within at least the portion of the captured image. In another method implementation, an attribute of the one or more attributes is an anomaly localization variable identifying a location of an anomaly detected within at least the portion of the captured image, wherein the location of the anomaly is defined relative to a surface area of the probe head visible within the captured image. In another method implementation, an attribute of the one or more attributes is an anomaly size variable quantifying a size of an anomaly detected within at least the portion of the captured image, wherein the size of the anomaly is determined based on one or more of a diameter, a width, a length, a bounding box, and a surface area. In another method implementation, an attribute of the one or more attributes is an anomaly class density variable quantifying a density of an anomaly class detected within at least the portion of the captured image. The density of the anomaly class can be determined based on one or more of an average size of one or more anomalies, within the anomaly class, detected within at least the portion of the captured image, an aggregate size of the one or more anomalies, within the anomaly class, detected within at least the portion of the captured image, and an aggregate surface area of the one or more anomalies, within the anomaly class, detected within at least the portion of the captured image.

One disclosed implementation can include a determined condition indicator that is associated with a particle build-up on a surface of the probe head. In another implementation, the determined condition indicator is associated with a chemical contamination of a surface of the probe head. In yet another implementation, the determined condition indicator is associated with a physical defect on a surface of the probe head. In many implementations, multiple condition indicators can be determined that are associated with different respective conditions, such as a combination of the aforementioned particle build-up, chemical contamination, and/or physical defect.

Another disclosed method can further include prompting a presentation of a notification, via a display device, including a warning alert based on the nonconformance record. The presented notification may further include a recommendation to initiate an inspection of the probe head, a maintenance action related to the probe head, or a replacement of the probe head.

In some implementations, the nonconformance record for the probe head further includes degradation data associated with the respective defect score corresponding to the one or more respective images of the sequence of captured images.

In other implementations, a remaining useful life metric for the probe head is predicted based on the degradation index.

Some implementations of the technology disclosed include capturing a sequence of images of the probe head, and constructing timeseries data using the sequence of captured images. The construction of the timeseries data can include processing the sequence of captured images to extract a feature from respective images of the sequence of captured images, analyzing the extracted feature corresponding to the respective images to determine data associated with the condition indicator over time, and generating a respective defect score corresponding to one or more respective images of the sequence of captured images. One implementation further includes determining, based on the timeseries data, a degradation index quantifying a rate of degradation for the probe head over time.

In another implementation of the technology disclosed, the method can include receiving a probe measurement, obtained by the probe head at a timestamp that lies within a pre-defined window of tolerance relative to the timestamp of the captured image, determining a corrective adjustment based, at least in part, on the defect score, and generating a corrected probe measurement based on the probe measurement and the corrective adjustment.

Some implementations include evaluating the generated defect score based on two or more pre-defined thresholds stored in memory. A respective pre-defined threshold of the two or more pre-defined thresholds can be defined based on one or more of: a particular feature, a particular condition indicator, a particular defect score value, a service lifetime of the probe head, and/or a timestamp of the captured image of the probe head. The nonconformance record for the probe head further includes data identifying at least one pre-defined threshold satisfied by the generated defect score.

The disclosed system can include an image capture triggering logic, a computer vision engine, and/or a notification logic. The computer vision engine can include one or more of an image processing logic, a measurement integrity logic, and/or a measurement correction logic.

In one implementation, the capturing of the image of the probe head is triggered by an image capture trigger criterion, the image capture trigger criterion being based on at least one of: a pre-defined time interval between respective captures, a pre-defined quantity of measurements obtained by the probe head between respective captures, a detection that a work product has been loaded onto a sample measurement area associated with the probe head, a detection that the work product has been unloaded from the sample measurement area associated with the probe head, and a detection that the probe head is obtaining a measurement.

In some implementations, generating the defect score based on the determined condition indicator comprises applying a calibration curve constructed using a previously obtained dataset. The calibration curve may be generated using labeled training data, such as historical captured images associated with known defect levels, and the curve may be updated dynamically based on new data. In other implementations, the defect score is determined by mapping the condition indicator to a normalized index constructed using unsupervised learning techniques or clustering of latent features from extracted image data. The calibration curve or degradation index used to generate the defect score may be use-case specific, probe-head-specific, application-specific, and/or user-defined. In some implementations, multiple different calibration curves or degradation indexes are maintained for different probe head models or different measurement use cases. Selection of the appropriate calibration curve or index can be determined based on a probe head identifier, a user setting, and/or automatically by system logic based on detected usage conditions.

In another implementation, the defect score is a weighted composite score derived from multiple features (e.g., anomalous features corresponding to different classes of anomalies) and/or condition indicators. The weighting may be fixed or dynamically determined based on environmental parameters, operational history, and/or recent user input, for example. Some implementations include assigning different weights to different anomaly classes or weighting anomalies based on location (e.g., defects near the tip of the probe head may be more significant than defects near the edge in certain applications).

In other implementations, multiple distinct defect scores may be generated in parallel using different sets of extracted features and/or different condition indicators. A first defect score may represent a particle accumulation indicator, a second may represent chemical residue contamination, a third may represent mechanical wear, and a fourth may represent estimated remaining useful life (RUL). These scores may be presented individually to a user or aggregated into a unified health score for the probe head.

The technology disclosed can include systems configured to define and store multiple types of thresholds for evaluating defect scores, including but not limited to: static value thresholds, percentile-based thresholds, time-varying thresholds, dynamically adaptive thresholds based on operating conditions, and/or thresholds defined in terms of predicted degradation trends. For example, the system may store a time-to-threshold value indicating how soon a defect score is projected to reach a maintenance threshold.

The communication paths involved in various implementations of the technology disclosed can be point-to-point over public and/or private networks. The communications may be performed over a wireless or a wired communication interface. The communications can occur over a variety of networks, e.g., private networks, VPN, MPLS circuit, or Internet, and can use appropriate application programming interfaces (APIs) and data interchange formats, e.g., Representational State Transfer (REST), JavaScript™ Object Notation (JSON), Extensible Markup Language (XML), Simple Object Access Protocol (SOAP), Java™ Message Service (JMS), Protobuf, and/or Java Platform Module System. All of the communications can be encrypted. The communication is generally over a network such as a LAN (local area network), WAN (wide area network), telephone network (Public Switched Telephone Network (PSTN), Session Initiation Protocol (SIP), wireless network, point-to-point network, star network, token ring network, hub network, and/or Internet, inclusive of the mobile Internet, via protocols such as EDGE, 3G, 4G LTE, 5G, Wi-Fi, and/or WiMAX. Additionally, a variety of authorization and authentication techniques, such as username/password, Open Authorization (OAuth), Kerberos, SecureID, digital certificates and more, can be used to secure the communications.

The technology disclosed herein can be implemented in the context of any computer-implemented system including a database system, a multi-tenant environment, or a relational database implementation like an Oracle™ compatible database implementation, an IBM DB2 Enterprise Server™ compatible relational database implementation, a MySQL™ and/or PostgreSQL™ compatible relational database implementation and/or a Microsoft SQL Server™ compatible relational database implementation and/or a NoSQL™ non-relational database implementation such as a Vampire™ compatible non-relational database implementation, an Apache Cassandra™ compatible non-relational database implementation, a BigTable™ compatible non-relational database implementation and/or an HBase™ and/or DynamoDB™ compatible non-relational database implementation. In addition, the technology disclosed can be implemented using different programming models like MapReduce™, bulk synchronous programming, MPI primitives, etc. and/or different scalable batch and stream management systems like Apache Storm™, Apache Spark™, Apache Kafka™, Apache Flink™, Truviso™ Amazon Elasticsearch Service™, Amazon Web Services™ (AWS), IBM Info-Sphere™, Borealis™, and/or Yahoo! S4™.

In some implementations, user-configurable graphical user interfaces (GUIs) allow customization of threshold levels, notification messages, data visualizations, and/or reporting behavior. The GUI may include a summary dashboard, alert history, trend graphs, defect score distributions, and/or raw image data. Interactive elements may allow the user to request further information, change settings, acknowledge alerts, and/or postpone alerts. The disclosed technology may further include user-configurable logging behavior. In one implementation, the system logs data for every captured image, including conforming and nonconforming images, while in another, only nonconforming images or images satisfying a particular trigger criterion are logged. Logged data may include, for example, the raw image, extracted features, condition indicators, defect scores, timestamps, probe head ID, sample ID, and/or operational parameters at the time of capture.

Many disclosed implementations leverage a measurement correction logic to automatically determine a corrective adjustment for measurement data obtained by the probe head. The adjustment may be calculated using a correction factor derived from the extracted features, condition indicators, and/or defect scores, optionally in combination with known measurement deviations associated with similar defect profiles in historical data. Corrective adjustments may include scaling, offsetting, or transforming the measurement data. In one implementation, the corrective adjustment is only applied after receiving a user approval via the GUI. The system may present the original measurement data, the corrected version, and the basis for the correction (e.g., detected defects and associated condition indicators) to the user for review. The user may accept, reject, or modify the correction. Information about the correction and user interaction may be stored for traceability. In another implementation, the corrective adjustment is automatically applied to all measurement data corresponding to captured images that meet a matching timestamp criterion, such as within a ±5 minute window. Matching may also be based on a wafer ID, lot ID, or sequential probe measurement number (e.g., based on similar time-window criteria, or via synchronization with the wafer loading/unloading process).

In certain implementations, measurement data is tagged with metadata indicating whether a correction has been applied, the version of the correction model used, and a confidence level for the applied correction. These tags can be used in downstream systems or quality assurance audits.

Some implementations of the disclosed system include predictive logic for estimating the remaining useful life of the probe head based on trends in defect scores over time. In some implementations, the degradation index is defined as a time series curve derived from a history of defect scores, and the slope or inflection points of the curve may be used to predict future defect score progression.

Other implementations may include a non-transitory computer readable storage medium storing instructions executable by a processor to perform a method as described above. Yet another implementation may include a system including memory and one or more processors operable to execute instructions, stored in the memory, to perform a method as described above.

The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the disclosed implementations.

While the present technology is disclosed by reference to the preferred implementations and examples detailed above, it is to be understood that these examples are intended in an illustrative rather than in a limiting sense. It is contemplated that modifications and combinations will readily occur to those skilled in the art, which modifications and combinations will be within the spirit of the technology and the scope of the following claims.

One or more features of the implementations disclosed can be combined with any base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

The implementations disclosed may be implemented as a method, apparatus, system or article of manufacture using standard programming or engineering techniques to produce software, firmware, hardware, or any combination thereof. The term “article of manufacture” as used herein refers to code or logic implemented in hardware or stored computer readable media such as optical storage devices, and volatile or non-volatile memory devices. Such hardware may include, but is not limited to, field programmable gate arrays (FPGAs), application-specific integrated circuits (ASICs), complex programmable logic devices (CPLDs), programmable logic arrays (PLAs), microprocessors, or other similar processing devices. One or more implementations of the technology disclosed, or elements thereof can be implemented in the form of a computer product including a non-transitory computer readable storage medium with computer usable program code for performing the method steps indicated. Furthermore, one or more implementations of the technology disclosed, or elements thereof can be implemented in the form of an apparatus including a memory and at least one processor that is coupled to the memory and operative to perform exemplary method steps. Yet further, in another aspect, one or more implementations of the technology disclosed or elements thereof can be implemented in the form of means for carrying out one or more of the method steps described herein; the means can include (i) hardware module(s), (ii) software module(s) executing on one or more hardware processors, or (iii) a combination of hardware and software modules; any of (i)-(iii) implement the specific techniques set forth herein, and the software modules are stored in a computer readable storage medium (or multiple such media).

The detailed description of some implementations will be better understood when read in conjunction with the appended drawings. To the extent that the figures illustrate diagrams of the functional blocks of various implementations, the functional blocks are not necessarily indicative of the division between hardware circuitry. Thus, for example, one or more of the functional blocks (e.g., processors or memories) may be implemented in a single piece of hardware (e.g., a general purpose signal processor or random access memory, hard disk, or the like). Similarly, the programs may be standalone programs, may be incorporated as subroutines in an operating system, may be functions in an installed software package, and the like. It should be understood that the various implementations are not limited to the arrangements and instrumentality shown in the drawings.

While the present invention is disclosed by reference to the preferred implementations and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims:

We claim as follows:

1. A computer-implemented method including:
capturing, using an imaging device, an image of a probe head;
processing the captured image using an image processing model to extract a feature of the captured image of the probe head;
analyzing the extracted feature to determine a condition indicator for the probe head;
generating a defect score based, at least in part, on the determined condition indicator;
evaluating the generated defect score based on a pre-defined threshold stored in a memory, wherein a particular defect score satisfying the pre-defined threshold indicates a nonconformance in association with the determined condition indicator; and
in response to the generated defect score satisfying the pre-defined threshold, logging a nonconformance record for the probe head in a data log, wherein the nonconformance record includes a timestamp and data identifying at least one of the extracted feature, the determined condition indicator, and the generated defect score.

2. The computer-implemented method of claim 1, wherein the extracted feature is an anomaly detection feature of the captured image, based on one or more attributes, wherein an attribute of the one or more attributes is:
an anomalous feature detection variable identifying one or more anomalous features detected within at least a portion of the captured image, wherein the anomalous feature is associated with at least one of: a signal intensity, a contrast, a brightness, a boundary attribute, and a region attribute.

3. The computer-implemented method of claim 1, wherein the extracted feature is an anomaly detection feature of the captured image, based on one or more attributes, wherein an attribute of the one or more attributes is:
an anomaly classification variable identifying one or more anomaly classes detected within at least a portion of the captured image, wherein the one or more anomaly classes identified by the anomaly classification variable are determined based, at least in part, on a detected anomalous feature.

4. The computer-implemented method of claim 1, wherein the extracted feature is an anomaly detection feature of the captured image, based on one or more attributes, wherein an attribute of the one or more attributes is:
an anomaly frequency variable quantifying a count of one or more anomalies detected within at least a portion of the captured image.

5. The computer-implemented method of claim 1, wherein the extracted feature is an anomaly detection feature of the captured image, based on one or more attributes, wherein an attribute of the one or more attributes is:
an anomaly localization variable identifying a location of an anomaly detected within at least a portion of a captured image, wherein the location of the anomaly is defined relative to a surface area of the probe head visible within the captured image.

6. The computer-implemented method of claim 1, wherein the extracted feature is an anomaly detection feature of the captured image, based on one or more attributes, wherein an attribute of the one or more attributes is:
an anomaly size variable quantifying a size of an anomaly detected within at least a portion of the captured image, wherein the size of the anomaly is determined based on one or more of a diameter, a width, a length, a bounding box, and a surface area.

7. The computer-implemented method of claim 1, wherein the extracted feature is an anomaly detection feature of the captured image, based on one or more attributes, wherein an attribute of the one or more attributes is:
an anomaly class density variable quantifying a density of an anomaly class detected within at least a portion of the captured image, wherein the density of the anomaly class is determined based on one or more of:
an average size of one or more anomalies, within the anomaly class, detected within at least the portion of the captured image,
an aggregate size of the one or more anomalies, within the anomaly class, detected within at least the portion of the captured image, and
an aggregate surface area of the one or more anomalies, within the anomaly class, detected within at least the portion of the captured image.

8. The computer-implemented method of claim 1, wherein the determined condition indicator is associated with a particle build-up on a surface of the probe head.

9. The computer-implemented method of claim 1, wherein the determined condition indicator is associated with a chemical contamination of a surface of the probe head.

10. The computer-implemented method of claim 1, wherein the determined condition indicator is associated with a physical defect on a surface of the probe head.

11. The computer-implemented method of claim 1, further including prompting a presentation of a notification, via a display device, including a warning alert based on the nonconformance record.

12. The computer-implemented method of claim 11, wherein the presented notification further includes a recommendation to initiate an inspection of the probe head, a maintenance action related to the probe head, and a replacement of the probe head.

13. The computer-implemented method of claim 1, further including:
capturing a sequence of images of the probe head;
constructing timeseries data using the sequence of captured images, including:
processing the sequence of captured images to extract a feature from respective images of the sequence of captured images,
analyzing the extracted feature corresponding to the respective images to determine data associated with the condition indicator over time, and
generating a respective defect score corresponding to one or more respective images of the sequence of captured images; and
determining, based on the timeseries data, a degradation index quantifying a rate of degradation for the probe head over time.

14. The computer-implemented method of claim 13, further including:
predicting, based on the degradation index, a remaining useful life metric for the probe head.

15. The computer-implemented method of claim 1, further including:
capturing, using an imaging device, another image of a probe head;
processing the other captured image using an image processing model to extract a feature of the other captured image of the probe head;
analyzing the extracted feature of the other captured image to determine an additional condition indicator for the probe head;
generating another defect score based, at least in part, on the additional condition indicator; and
logging a quality record for the probe head in a data log, wherein the quality record includes a timestamp and data identifying at least one of the extracted feature of the other captured image, the additional condition indicator, and the other generated defect score.

16. The computer-implemented method of claim 1, further including evaluating the generated defect score based on two or more pre-defined thresholds stored in the memory,
wherein a respective pre-defined threshold of the two or more pre-defined thresholds is defined based on one or more of: a particular feature, a particular condition indicator, a particular defect score value, a service lifetime of the probe head, and a timestamp of the captured image of the probe head, and
wherein the nonconformance record for the probe head further includes data identifying at least one pre-defined threshold satisfied by the generated defect score.

17. The computer-implemented method of claim 1, further including:
receiving a probe measurement, obtained by the probe head at a timestamp that lies within a pre-defined window of tolerance relative to the timestamp of the captured image;
determining a corrective adjustment based, at least in part, on the defect score; and
generating a corrected probe measurement based on the probe measurement and the corrective adjustment.

18. The computer-implemented method of claim 1, wherein the capturing of the image of the probe head is triggered by an image capture trigger criterion, the image capture trigger criterion being based on at least one of: a pre-defined mode of operation related to the capturing of the image, a pre-defined time interval between respective captures, a pre-defined quantity of measurements obtained by the probe head between respective captures, a detection that a work product has been loaded onto a sample measurement area associated with the probe head, a detection that the work product has been unloaded from the sample measurement area associated with the probe head, a detection that the probe head is idle, and a detection that the probe head is obtaining a measurement.

19. A system including one or more processors coupled to memory, the memory being loaded with computer instructions that, upon execution by the processors, implement operations comprising:
capturing, using an imaging device, an image of a probe head;
processing the captured image using an image processing model to extract a feature of the captured image of the probe head;
analyzing the extracted feature to determine a condition indicator for the probe head;
generating a defect score based, at least in part, on the determined condition indicator;
evaluating the generated defect score based on a pre-defined threshold stored in a memory, wherein a particular defect score satisfying the pre-defined threshold indicates a nonconformance in association with the determined condition indicator; and
in response to the generated defect score satisfying the pre-defined threshold, logging a nonconformance record for the probe head in a data log, wherein the nonconformance record includes a timestamp and data identifying at least one of the extracted feature, the determined condition indicator, and the generated defect score.

20. A non-transitory computer readable storage medium storing computer program instructions that, upon execution by a processor, implement operations comprising:
capturing, using an imaging device, an image of a probe head;
processing the captured image using an image processing model to extract a feature of the captured image of the probe head;
analyzing the extracted feature to determine a condition indicator for the probe head;
generating a defect score based, at least in part, on the determined condition indicator;
evaluating the generated defect score based on a pre-defined threshold stored in a memory, wherein a particular defect score satisfying the pre-defined threshold indicates a nonconformance in association with the determined condition indicator; and
in response to the generated defect score satisfying the pre-defined threshold, logging a nonconformance record for the probe head in a data log, wherein the nonconformance record includes a timestamp and data identifying at least one of the extracted feature, the determined condition indicator, and the generated defect score.
